(19) United States
(12) Patent Application Publication
(10) Pub. No.: US 2004/0205671 A1
(43) Pub. Date: Oct. 14, 2004

(54) Natural-language processing system

(76) Inventors: Tatsuya Sukehiro, Osaka (JP); Shin Torigoe, Osaka (JP); Yasuhiro Kawakita, Osaka (JP); Satoshi Nakagawa, Hyoga (JP); Toshihiko Matsunaga, Osaka (JP)

Correspondence Address: VENABLE, P.O. Box 34385, Washington, DC, 20043-9998, US

(21) Appl. No.: 09/948,935

(22) Filed: Sep. 10, 2001

(30) Foreign Application Priority Data
Sep. 13, 2000 (JP) 277761/00
Sep. 14, 2000 (JP) 280178/00
Sep. 18, 2000 (JP) 281194/00
Sep. 18, 2000 (JP) 281256/00
Sep. 19, 2000 (JP) 283038/00

(51) Int. Cl. G06F 17/00

(52) U.S. Cl. 715/532; 715/536

(57) ABSTRACT

A natural-language processing system such as a machine-translation system employs a tree structure of increasingly specialized system dictionaries and attaches user dictionaries to individual system dictionaries in the tree, or helps users edit their user dictionaries by displaying lists of unknown words encountered in translations, or uploads processing programs such as translation engines to a dictionary server to make dictionary access more efficient, or combines a source document and a machine translation thereof into a single document in such a way that the reader of the translation can conveniently see the original source text, or automatically converts contact information in a source document to contact information more suitable for inclusion in a machine translation of the document.

### BACKGROUND OF THE INVENTION

The present invention relates generally to natural-language processing systems, and in particular to machine translation systems.

By providing convenient on-line access to documents written in foreign languages, the Internet has stimulated the demand for machine translation. There is a strong demand for translation of on-line documents between Japanese and English, for example. One current trend is to provide a machine-translation capability on a server connected to a network, such as the Internet, and offer machine-translation service to a large and substantially unrestricted community of users.

The machine-translation capability is typically provided by one or more computer programs referred to as translation engines, and a set of machine-readable dictionaries. Even for a single source-target language pair, it is common to employ multiple dictionaries, including a general dictionary and a various more specialized dictionaries, reflecting the fact that a word may have different specialized meanings in different fields. If provided as part of the machine translation system, these dictionaries are referred to as system dictionaries. There may also be user dictionaries, which are created and maintained by individual users of the translation service, and reflect the users' individual specialties and preferences. A single user may maintain different user dictionaries for different specialized fields.

The construction and maintenance of dictionaries present several problems. As translation technology improves, machine translation is being applied in an increasing range of fields. It is unrealistic to expect a machine translation system to come equipped with specialized dictionaries covering every field in which translation services may be required. Usually, the machine translation system provides a few specialized system dictionaries covering comparatively broad categories of fields, and leaves the users to fulfill further dictionary needs with their own user dictionaries.

In a machine translation system that is accessed by many users, however, such as a machine translation system located in a server on the Internet, the user dictionaries can easily overwhelm the server, which must provide storage space for them. Moreover, much storage space is wasted because of duplication of the same information in many different user dictionaries.

This problem cannot easily be solved by the sharing of user dictionaries. It takes considerable knowledge to construct a specialized dictionary, and one user may be far from satisfied with dictionary information entered by another user. There is also the problem of mistaken information being entered, sometimes intentionally as a prank.

Choosing the dictionaries to use for a particular translation task presents another problem. Japanese Unexamined Patent Application 10-21222 suggests that when a document is obtained from the Internet, its uniform resource locator (URL) can be used to select a set of relevant specialized dictionaries automatically, thus sparing the user the trouble and difficulty of having to specify the dictionaries. In many cases, however, the uniform resource locator serves only to identify the document uniquely, and does not adequately describe the field or genre of the document. This is particular true on the Internet, where documents belonging to an extremely large number of different fields and genres can be found. Moreover, even when a field or genre can be identified, it may be difficult to determine which specialized dictionaries are relevant to that field or genre.

The maintenance of user dictionaries presents further problems for the system users. In conventional machine translation systems, to add entries to a user dictionary, the user must switch the machine translation system into a user dictionary update mode, then type in each new entry from a keyboard, all of which is time-consuming and inconvenient. Furthermore, the user often first becomes aware of the need to add a dictionary entry when an untranslatable word appears in a translation result, but after the user switches into the dictionary update mode, the translation result is no longer visible. Even if the translation result and a dictionary update window can both be displayed on the same screen, the part of the translation result including the untranslatable word may be annoyingly hidden by the dictionary update window. Furthermore, the user often does not know how to translate the unknown word, and must hunt for it in other dictionaries, often in dictionaries that are not available in electronic form.

One approach to the problems of dictionary construction, maintenance, and selection is to construct a distributed machine translation system in which a centralized dictionary server stores a set of dictionaries that can be used by translation engines residing on a plurality of other servers, which are linked to the dictionary server by a communication network. The dictionary server can be organized to provide adequate dictionary storage space, and a dedicated staff can work to keep the dictionaries up to date, by adding new vocabulary, for example, and making other changes to reflect changes in natural-language usage.

When the amount of translation to be done is comparatively small, a machine translation server can advantageously use the dictionary server by accessing it to look up words as the need arises during the translation process. When the amount of translation to be done is comparatively large, the machine translation server can more advantageously download dictionaries from the dictionary server and use the downloaded dictionaries during the translation process. In both cases, however, the transfer of dictionary contents from the dictionary server to the machine translation server takes time and consumes network bandwidth. This type of distributed machine translation system, accordingly, tends to suffer from network congestion.

The above problems are not unique to machine translation systems; they can also occur in other types of natural-language processing systems.

Although the quality of machine translation is improving, there are still many times when the reader of a translated document would like to be able to compare the translation with the source text to check for possible translation mistakes. Japanese Unexamined Patent Application No. 10-74204 describes a system that embeds hypertext links in both the source document and the translated document, enabling the user to find corresponding parts of the two documents easily.

A problem in this system is that the source document and translated document remain separate documents. After being translated, the source document may be modified. Modifications of hypertext documents are quite common; one of the principles of hypertext is that hypertext documents should be freely modifiable. Thus when the reader of a translated document retrieves the source text through a link in the translated document, the source text may no longer match the translated document. The source document may even have been deleted.

A possible solution to this problem is to combine the source document and translated document into a single mixed document, with each paragraph appearing first in the source language, for example, then in translation, but this display format destroys the continuity of the document, making it difficult to read, especially for readers who do not want to see the entire source text.

Machine translation is also used by information providers, to translate the information they provide into different languages for distribution on, for example, the Internet. The distributed information often includes contact information, such as the electronic mail address of the author of the document, so that readers of the distributed information can contact the information provider. Conventional machine translation processes leave this contact information unchanged. A resulting problem is that readers of the translated document may send electronic mail written in the translation target language to the document author, who may not be able to read the translation target language.

This problem is common at companies that do business in more than one country. One solution that is sometimes adopted is to change the electronic mail address in the translated document manually to the address of a foreign business office where the translation target language is understood, but that requires further manual processing of each translated document, which is inconvenient, especially if the number of translated documents generated by the company is large. Another possible solution is to have the person who creates the source document create a separate source document, with suitable contact information, for each language into which the source document will be translated, but that is equally inconvenient. Yet another solution is to provide a list of electronic mail addresses in the source document and indicate which address should be used for replies written in each language into which the document will be translated, but such a list may confuse the document reader, and the space taken up by the list may limit the space available for other document content.

### SUMMARY OF THE INVENTION

An object of the present invention is to simplify the creation and maintenance of machine-readable dictionaries used in a natural-language processing system.

Another object of the invention is to enable appropriate dictionaries to be selected from the dictionary system for use in specific natural-language-processing tasks.

Another object is to enable the knowledge of the community of users of the dictionary system to be pooled, so that one user can benefit from the knowledge of another user.

Another object is to reduce communication congestion in a distributed natural-language-processing system including a dictionary system residing on one apparatus and a processing system residing on another apparatus.

Another object is to provide a convenient and reliable way to compare machine-translated text with the source text.

Another object is to provide readers of machine-translated documents with improved contact information.

According to a first aspect of the invention, a machine-readable dictionary system used for natural-language processing includes system dictionaries and user dictionaries. The system dictionaries are organized as a tree, with a generalized terminology dictionary at the root node and increasingly specialized terminology dictionaries located at increasingly deeper levels in the tree structure. Each specialized terminology dictionary pertains to a particular category of natural-language material, such as a particular field or genre. Each user dictionary is attached to a system dictionary in the tree. The system also includes an editor unit that attaches new user dictionaries, and adds user-supplied information to the user dictionaries.

When this dictionary system is used, the category of the material to be processed is determined, and the dictionaries to be used are preferably selected as follows. The specialized terminology dictionary pertaining to the category is selected, and all system dictionaries on the path from that specialized terminology dictionary up to the generalized terminology dictionary at the root node in the tree structure, including the generalized terminology dictionary itself, are selected. User dictionaries attached to the selected system dictionaries are also selected.

The dictionary system is preferably modifiable by transferring entries into a system dictionary from the user dictionaries attached to that system dictionary, or from the user dictionaries attached to the dictionary just above that system dictionary in the tree structure, provided the entries appear in a sufficient number of attached user dictionaries. If necessary, a new subordinate system dictionary may be created to hold the entries. Entries appearing in a sufficient number of specialized terminology dictionaries may also be transferred into a common parent dictionary.

The above tree structure with attached user dictionaries simplifies the creation and maintenance of dictionaries by enabling these processes to be automated. It also facilitates the selection of an appropriate set of dictionaries for use in a particular task, and enables users' knowledge to be pooled by the transfer of entries from user dictionaries into system dictionaries.

According to a second aspect of the invention, a machine translation system provides enhanced features for dealing with unknown words in the document being translated, such as a feature that displays a list of the unknown words and enables the user to enter translations for them, thereby creating new entries in a user dictionary. Preferably, the list is displayed together with the translation result, so that the user can enter translations while viewing the context in which the words are used. The system may also display candidate translations for the unknown words, the candidate translations being obtained from dictionaries that were not selected for use in the translation process. Furthermore, the system may translate unknown words by using these candidate translations, but indicate that the translation comes from a non-selected dictionary. These features simplify the maintenance and editing of user dictionaries.

According to a third aspect of the invention, a distributed natural-language processing system resides on at least a first apparatus and a second apparatus. The first apparatus has a natural-language-processing program, an uploader for sending this program to the second apparatus, and a commander for sending natural-language data to be processed to the second apparatus. The second apparatus has a dictionary. The second apparatus stores the program received from the first apparatus, then processes the data received from the first apparatus by executing the stored program. The program makes use of the dictionary. Congestion is reduced because transferring the program and data from the first apparatus to the second apparatus is more efficient than repeatedly transferring dictionary information from the second apparatus to the first apparatus.

According to a fourth aspect of the invention, a machine translation system generates a marked-up translation result including source text, translated text, and markup symbols that enable a display system to display the source text or translated text selectively, in response to user operations. For example, certain markup symbols may include machine-executable script, and the source text may be embedded within the script, so that the source text is normally hidden but can be displayed at the user's command. Alternatively, the source text and the translated text may be separately identified by markup symbols, enabling the user to display one text or the other by designating the translation source language or target language. The user can thus compare the translated text with the source text conveniently, without being forced to view unwanted source text, and can be sure that the source text is the actual text from which the translated text was obtained.

According to a fifth aspect of the invention, a machine translation system extracts contact information from a document to be translated from a first language into a second language, generates new contact information suitable for the second language, and inserts the new contact information into the translation result in place of the original contact information. The new contact information may be, for example, the electronic mail address of a machine translation system that translates electronic mail from the second language to the first language, then forwards the translated electronic mail.

### BRIEF DESCRIPTION OF THE DRAWINGS

In the attached drawings:

FIG. 1 is a block diagram of a machine translation network system embodying the first aspect of the invention;

FIG. 2 illustrates the tree structure of the dictionary information section in FIG. 1;

FIG. 3 is a flowchart illustrating the operation of adding new user dictionary entries in FIG. 1;

FIG. 4 is a flowchart illustrating the machine-translation operation of the machine translation network system in FIG. 1;

FIG. 5 is a functional block diagram of another machine translation network system embodying the first aspect of the invention;

FIG. 6 is a flowchart describing the operation of the terminology incorporator in FIG. 5;

FIG. 7 shows an example of a table compiled by the terminology incorporator in FIG. 5;

FIG. 8 is a functional block diagram of still another machine translation network system embodying the first aspect of the invention;

FIG. 9 is a flowchart describing the operation of the dictionary information unifier in FIG. 8;

FIG. 10 is a functional block diagram of yet another machine translation network system embodying the first aspect of the invention;

FIG. 11 is a flowchart describing the operation of the dictionary splitter-generator in FIG. 10;

FIG. 12 shows an example of a table compiled by the dictionary splitter-generator in FIG. 10;

FIG. 13A illustrates a specialized terminology dictionary with user dictionaries attached;

FIG. 13B illustrates the specialized terminology dictionary in FIG. 13A with newly generated subordinate dictionaries;

FIG. 14 is a block diagram of a machine translation system illustrating the second aspect of the invention;

FIG. 15 shows a screen displayed by the display section in FIG. 14;

FIG. 16 illustrates the sequence of operations carried out by the machine translation system in FIG. 14;

FIG. 17 is a block diagram of another machine translation system illustrating the second aspect of the invention;

FIG. 18 shows a screen displayed by the display section in FIG. 17;

FIG. 19 illustrates the sequence of operations carried out by the machine translation system in FIG. 17;

FIG. 20 is a block diagram of still another machine translation system illustrating the second aspect of the invention;

FIG. 21 shows a screen displayed by the display section in FIG. 20;

FIG. 22 illustrates the sequence of operations carried out by the machine translation system in FIG. 20;

FIG. 23 is a block diagram of a distributed machine translation system embodying the third aspect of the invention;

FIG. 24 shows the structure of the system in FIG. 23 in more detail;

FIG. 25 is a sequence diagram illustrating the operation of the distributed machine translation system in FIG. 23;

FIG. 26 is a block diagram of a conventional distributed machine translation system;

FIG. 27 is a block diagram of a machine translation and document display system embodying the fourth aspect of the invention;

FIG. 28 is a block diagram showing the internal structure of the text converter in FIG. 27;

FIG. 29 is a sequence diagram illustrating the operation of the machine translation and document display system in FIG. 27;

FIG. 30A shows part of a source hypertext document;

FIG. 30B shows part of a mixed hypertext document generated from the source hypertext document in FIG. 30A;

FIG. 30C shows part of a display generated from the mixed hypertext document in FIG. 30B;

FIG. 31 is a block diagram of another machine translation and document display system embodying the fourth aspect of the invention;

FIG. 32A shows part of a source hypertext document;

FIG. 32B shows part of a mixed hypertext document generated from the source hypertext document in FIG. 32A;

FIG. 32C shows part of a display generated from the mixed hypertext document in FIG. 32B;

FIG. 32D shows part of another display generated from the mixed hypertext document in FIG. 32B;

FIG. 33 is a sequence diagram illustrating the operation of the machine translation and document display system in FIG. 31;

FIG. 34 is a block diagram of a machine translation system embodying the fifth aspect of the invention;

FIG. 35 illustrates the conversion of an electronic mail address by the machine translation system and the consequent routing of electronic mail;

FIG. 36 illustrates the routing of electronic mail in a conventional system that does not convert electronic mail addresses;

FIG. 37 is a sequence diagram illustrating the operation of the machine translation system in FIG. 34;

FIG. 38 is a block diagram of another machine translation system embodying the fifth aspect of the invention; and

FIG. 39 is a sequence diagram illustrating the operation of the machine translation system in FIG. 38.

### DETAILED DESCRIPTION OF THE INVENTION

Embodiments of the invention will be described with reference to the attached drawings, starting with matters common to several of the embodiments.

Many of the embodiments below concern hypertext documents, that is, documents with embedded links to other documents, or to other parts of the same document. The links are embedded as symbols, sometimes referred to as anchor tags or a-tags, in a markup language such as the well-known hypertext markup language (HTML). Incidentally, HTML is based on the standard generalized markup language (SGML). The markup language may include other types of tags specifying font and format information, or including machine-executable script.

A hypertext document marked up with HTML tags is sometimes referred to as an HTML document or an HTML file. HTML files may also include digitized sound and pictures, making a hypertext document a multimedia document.

One of the well-known features of hypertext is that when a hypertext document is displayed, the user can select certain items in the document by moving a cursor to the item with a pointing device such as a mouse, then pressing a button or key; these operations are referred to as ‘clicking on’ the item. Clicking operations can be used to follow hypertext links from one document to another and for various other purposes, depending on tags embedded in the document. An item that has been tagged so as to respond to clicks is said to be ‘clickable.’

Many hypertext documents are currently available on the Internet through a hypertext system known as the World Wide Web. These documents are commonly referred to as Web pages. A hypertext document that serves as a main page or entry page to the information a person or organization makes available on the Internet is also referred to as a home page.

The machine translation systems described below make use of dictionaries that store word information in the form of entries, each entry comprising a key and a value. Typically, the key is a word in a first language, and the value is a word in a second language, the value being a translation of the key.

In general, a machine translation processor includes a software component comprising a machine translation program and associated data (other than dictionary data), and a hardware component such as a central processing unit (CPU) that executes the machine translation program. The term ‘translation engine’ denotes the software component of the processor. A translation engine typically executes in the main memory of a server or some other type of computer.

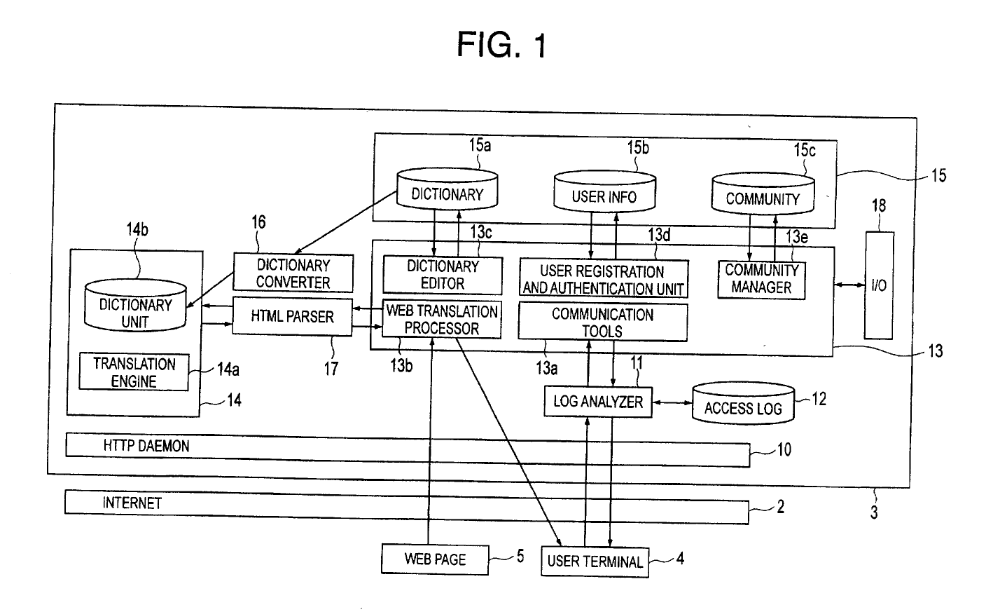

As an embodiment of the first aspect of the invention, FIG. 1 shows a block diagram of a machine translation network system 1 in which the Internet 2 provides access to a server 3 from a user terminal 4. The server 3 may also be linked to other servers (not visible) through the Internet 2.

The server 3 has a hypertext transfer protocol daemon or HTTP daemon 10, a log analyzer 11, an access log storage unit 12, a Web server 13, a machine translation system 14, a dictionary data base 15, a dictionary converter 16, an HTML parser 17, and an input-output device 18.

The Web server 13 functionally comprises a set of communication tools 13a, a Web translation processor 13b, a dictionary editor 13c, a user registration and authentication unit 13d, and a community manager 13e. The machine translation system 14 includes a translation engine 14a and a dictionary unit 14b. The dictionary data base 15 includes a dictionary information section 15a, a user information (INFO) section 15b, and a community information section 15c.

The user terminal 4 gives instructions for the retrieval of documents from the Internet 2. The documents retrieved in the present embodiment are HTML Web pages. A user who has contracted for translation service with the operator of the server 3 can use the user terminal 4 to instruct the server 3 to translate a retrieved Web page into a designated language and deliver the translation. The user can give this instruction by, for example, filling in a translation instruction entry field on a home page provided by the server 3, by introducing a translation instruction code into the document-identifying information given to the server 3 to specify the Web page, or by specifying the translation result as a hypertext link.

In the server 3, the HTTP daemon 10 transfers Web pages according to a predetermined hypertext transfer protocol.

The log analyzer 11 keeps an access log including information about the user terminal 4 and Web pages that are requested from the user terminal 4, stores the access log in the access log storage unit 12, and logs users of the Web server 13 in and out. Log-in requires authentication by a password.

In the Web server 13, the communication tools 13a provide various communication functions needed for communication with the user terminal 4 and retrieval of requested Web pages. The Web translation processor 13b, the dictionary editor 13c, the user registration and authentication unit 13d, and the community manager 13e provide functions related to the translation of Web pages.

When a retrieved Web page needs to be translated, the Web translation processor 13b sends it to the machine translation system 14 through the HTML parser 17. The HTML parser 17 uses HTML tag information and the like to extract the text of the retrieved Web page, furnishes the text, stripped of HTML tags and other non-text information, to the machine translation system 14, then restores the HTML tags and other non-text information to the translation result, which thus becomes an HTML document.

In the machine translation system 14, the translation engine 14a carries out the machine translation process by using dictionary information stored in the dictionary unit 14b. The dictionary information stored in the dictionary unit 14b is obtained from the dictionary information section 15a of the dictionary data base 15, but is converted by the dictionary converter 16 for use by the translation engine 14a.

The translation activation and translation output methods described by the present inventors in Japanese Unexamined Patent Applications 7-202721 and 7-202734 can be applied to Web pages retrieved as described above.

In this embodiment of the first aspect of the invention, characterizing features are present in the dictionary editor 13c, user registration and authentication unit 13d, and community manager 13e in the Web server 13, and in the dictionary data base 15 and input-output device 18.

The dictionary information section 15a in the dictionary data base 15 stores various types of dictionary information. The information is stored hierarchically in three types of dictionaries: general terminology dictionaries, specialized terminology dictionaries, and user dictionaries. One feature of the present embodiment is that the hierarchy is basically implemented through a tree structure.

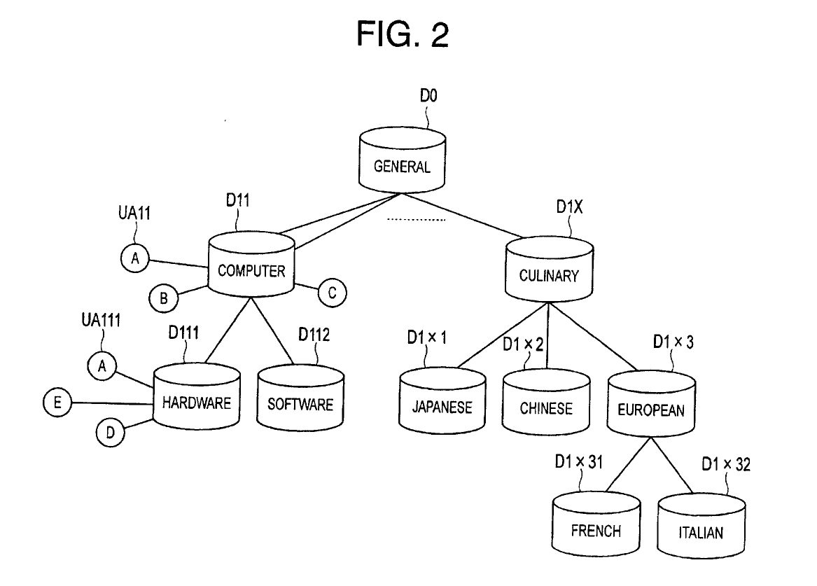

Referring to FIG. 2, the root node of the tree structure is a general terminology dictionary D0. At the next level are specialized terminology dictionaries D11 to D1x corresponding to comparatively broad categories of fields or genres. Each of these fields or genres may be further classified into more narrow fields or genres, with corresponding specialized terminology dictionaries in the next level of the tree structure. This categorization process continues until the leaf nodes of the tree are reached. The depth of the hierarchical structure (the number of branches between the root and a leaf node) may vary from place to place in the tree structure.

In FIG. 2, for example, in the level below a specialized computer terminology dictionary D11, there are a specialized computer hardware terminology dictionary D111 and a specialized computer software dictionary D112. In the level below the dictionary D1x dealing with culinary terminology, there are a specialized terminology dictionary D1x1 for Japanese cuisine, a specialized terminology dictionary D1x2 for Chinese cuisine, and a specialized terminology dictionary D1x3 for European cuisine. In the level below the dictionary D1x3 for European cuisine, there are a specialized terminology dictionary D1x31 for French cuisine and a specialized terminology dictionary D1x32 for Italian cuisine.

Although this is not illustrated, there may be a specialized terminology dictionary having just one subordinate specialized terminology dictionary. For example, a dictionary of golf terminology might have only a single subordinate dictionary, dealing with miniature golf.

The general terminology dictionary and specialized terminology dictionaries described above are system dictionaries; that is, they are provided and maintained by the server 3 and its staff. The dictionary information section 15a may include separate system dictionary trees for different source-target language pairs.

The dictionary information section 15a also includes user dictionaries, and the way in which they are built into the tree structure is another feature of this embodiment. A user dictionary is a dictionary that can be edited by a user. As explained below, the Web server 3 provides a simple way for users to create user dictionaries and attach them to specialized terminology dictionaries, to hold terms related to the same fields or genres as those specialized terminology dictionaries. Each user dictionary is attached to only one specialized terminology dictionary, but there is no limit on the number of specialized terminology dictionaries for which a user can create user dictionaries.

In FIG. 2, for example, user A has attached user dictionaries UA11 and UA111 to the specialized computer terminology dictionary D11 and the specialized computer software terminology dictionary D111. A user may also attach a user dictionary to the general terminology dictionary D0, for entry of terms not related to any particular field or genre.

The specialized terminology dictionaries (D11 to D1x32) and their attached user dictionaries will be referred to below as community dictionaries because, as will become clear in succeeding embodiments, knowledge obtained from the community of users can be incorporated into the specialized terminology dictionaries.

The user information section 15b in the dictionary data base 15 stores information about users who have contracted for use of the server 3 with the operator of the server 3. The stored information includes information identifying registered users who are allowed to receive machine translation service, and identifying user dictionaries created by these users.

The community information section 15c in the dictionary data base 15 stores information describing the structure of the community dictionaries in the dictionary structure in FIG. 2.

The dictionary editor 13c in the Web server 13 edits the dictionary information section 15a.

The user registration and authentication unit 13d in the Web server 13 registers users, verifies that users who attempt to access the server 3 are qualified to do so, confirms that users who request machine translation service are qualified to receive the service, and determines whether they are permitted to perform operations on user dictionaries.

The community manager 13e in the Web server 13 manages the information in the community information section 15c. For example, when the field or genre of a Web page to be translated is determined, the community manager 13e uses the information in the community information section 15c to decide which dictionaries to use. Specifically, the community manager 13e selects the specialized terminology dictionary matching the field or genre of the Web page, any other system dictionaries disposed on the path from that specialized terminology dictionary up to and including the general terminology dictionary, and any user dictionaries that the user who requested the translation has attached to the selected system dictionaries.

For example, if user A requests the translation of a Web page concerned with computer hardware, the community manager 13e decides to employ user dictionary UA111, the specialized computer hardware terminology dictionary D111, user dictionary UA11, and the specialized computer terminology dictionary D11, in this order of priority. (The general terminology dictionary D0 is always used.)

The input-output device 18 is used by the staff of the server 3 to start the dictionary editing process and to edit dictionaries.

The machine translation network system 1 in this embodiment is capable of responding to translation requests from multiple users simultaneously. A single paired machine translation system 14 and HTML parser 17 can operate on a time-sharing basis to respond to multiple translation requests simultaneously, for example, or the system may include multiple pairs of these facilities, which respond to separate translation requests simultaneously. In the latter case, multiple translation requests can be handled simultaneously by loading copies of a machine translation program into the main memories of multiple central processing units (CPUs) with which the server 3 is provided.

If a separate machine translation system 14 and HTML parser 17 are devoted to each Web-page translation request, the dictionary unit 14b in the machine translation system 14 is loaded with contents of the dictionaries selected according to the field or genre of the Web page, this information being transferred to the dictionary unit 14b through the dictionary converter 16 from the dictionary data base 15.

Next, relevant operations of the machine translation network system 1 in FIG. 1 will be described.

The first operation that will be described is that of adding entries to a user dictionary. The information exchanged between the server 3 and user terminal 4 during this operation is in the HTTP format.

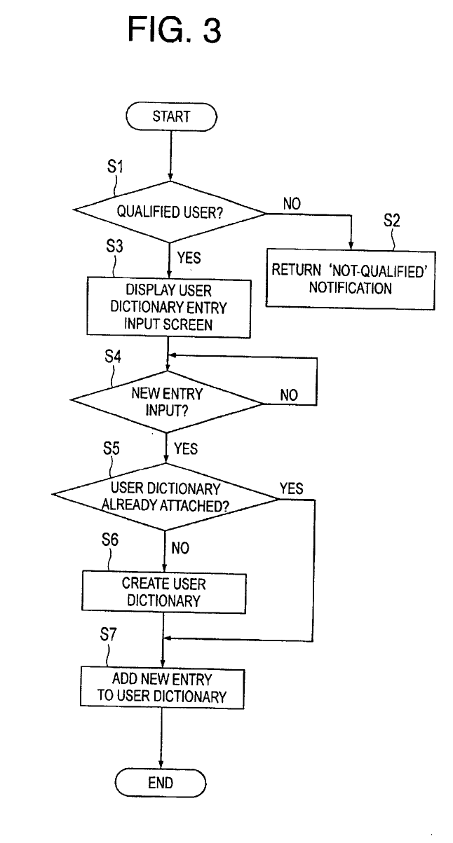

When the user uses the user terminal 4 to display a certain Web page supplied by the server 3, for example, then gives a command to enter the dictionary editing mode, the server 3 starts the process shown in FIG. 3. First, the server 3 (the user registration and authentication unit 13d) decides whether the user is qualified to edit the dictionary information section 15a (step S1).

If the user is not qualified to edit the dictionary information section 15a, notification to that effect is returned to the user, and the process is terminated (step S2).

If the user is qualified to edit the dictionary information section 15a, the server 3 (the community manager 13e) obtains information displaying the tree structure of system dictionaries in the dictionary information section 15a, such as an outline or map of the tree structure. This information is obtained from the community information section 15c and sent to the user terminal 4 as part of a user-dictionary editing information input screen or user dictionary entry input screen (step S3). The server 3 then waits to receive new entry information from the user terminal 4 (step S4).

When the user dictionary entry input screen is displayed, the user uses it to create a new dictionary entry, uses the displayed tree structure to indicate the system dictionary to which the new entry is to be attached, and sends this information to the server 3. For simplicity, it will be assumed below that information for only one new entry is sent, although it may be possible to send information for multiple entries at once.

Upon receiving the new entry information, the server 3 (the user registration and authentication unit 13d) refers to the user information section 15b, or the user information section 15b and community information section 15c, to decide whether this particular user already has a user dictionary attached to the indicated system dictionary (step S5).

If the user does not yet have a user dictionary attached to the indicated system dictionary, the dictionary editor 13c creates a new user dictionary for the user and attaches it to the indicated system dictionary (step S6). Appropriate information describing the new user dictionary is placed in the user information section 15b and community information section 15c at this time.

Finally, the entry received from the user terminal 4 is added to the user dictionary that is now attached to the indicated system dictionary (step S7), completing the user dictionary entry process.

Although the dictionary information section 15a may store each user dictionary in a separate storage area, since there may be many user dictionaries, it is preferable to store all user dictionary entries in a single area and attach a code to each entry, indicating the particular user dictionary to which the entry belongs. In this case, a new user dictionary is created simply by generating a new code.

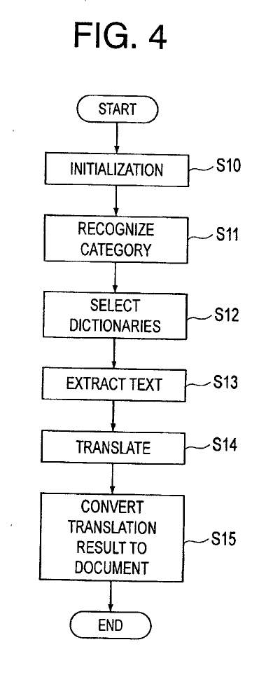

Next, the process of machine translation of a Web page will be described with reference to the flowchart in FIG. 4.

The machine translation process shown in FIG. 4 is initiated by the server 3 (the Web translation processor 13b) when the need arises to translate a Web page.

The need to translate a Web page arises when, for example, a user instructs the server to deliver a Web page in translated form, or a user requests a translation after seeing a Web page displayed in its original form. A user may also request a translation of a Web page that the user has created and intends to put up on the Internet.

When the server 3 (the Web translation processor 13b) initiates the machine translation process in FIG. 4, it begins with an initialization process (step S10) that includes the allocation of computational resources, such as time slots to be used by the machine translation system 14.

Next, the category of the Web page to be translated is recognized; that is, its field or genre is recognized (step S11). The user may specify the field or genre from the user terminal 4, or the server 3 (the Web translation processor 13b) may recognize the field or genre automatically. Possible methods of automatic recognition include both those described in Japanese Unexamined Patent Application No. 10-21222 and other conventional methods, such as counting the occurrences of key words associated with various fields and genres. If more than one category is recognized, then the narrowest category, ranking lowest in the hierarchy of community dictionary categories, is selected.

After determining the category of the Web page to be translated, the server 3 selects the dictionaries to be used in the machine translation process and places these dictionaries in a usable state (step S12). As noted above, the selected dictionaries include all system dictionaries in the community dictionary tree structure disposed on the path leading from the specialized terminology dictionary associated with the category of the Web page up to and including the general terminology dictionary.

The selected dictionaries also include all user dictionaries attached to the selected system dictionaries by the user requesting the translation. These dictionaries are preferably searched before the system dictionaries, so that the entries in the user's own user dictionaries have priority over the entries in the system dictionaries.

For certain types of translation, the selected dictionaries may also include the user dictionaries attached to the selected system dictionaries by other users. These other user dictionaries are preferably searched after the system dictionaries; that is, they are searched only to find words not appearing in the system dictionaries or in the user dictionaries belonging to the user who requested the translation.

Other user's dictionaries can be usefully employed to translated Web pages retrieved from the Internet, for example, so that the user requesting the translation obtains the benefit of other user's knowledge. If the translation is requested by a registered user who intends to put up the translated Web page for other users to retrieve, however, the server 3 preferably selects only that user's own user dictionaries, to give the user greater control over the translation result.

The contents of the selected dictionaries are converted as necessary and transferred from the dictionary information section 15a to the dictionary unit 14b, if they are not already present in the dictionary unit 14b. If non-selected dictionary contents are present in the dictionary unit 14b, then step S12 restricts access to the contents of the selected dictionaries.

Next, the HTML parser 17 extracts the text to be translated from the Web page (step S13), the translation engine 14a uses the selected dictionaries to translate the text (step S14), and the HTML parser 17 restores non-text information such as HTML tags to the translation result, converting the translation result to a hypertext document (step S15). The result is a translated Web page.

The dictionary tree structure of this embodiment enables translation results of comparatively good quality to be obtained with, on the average, comparatively little expenditure of time, because the translation process can make use of all relevant specialized terminology dictionaries and user dictionaries without having to scan the contents of dictionaries that are not relevant.

When a document in a highly specialized field or genre is translated, for example, the quality of the translation is improved by the use of corresponding specialized terminology dictionaries from low levels in the community dictionary hierarchy, and the user dictionaries attached to these specialized terminology dictionaries. When the document is not so specialized, however, only dictionaries from higher levels in the tree structure are used, enabling a translation of adequate quality to be obtained in a short time.

This embodiment thus provides an effective means of translating documents obtained from the Internet, which span a wide range of specialization, in regard to both content and genre.

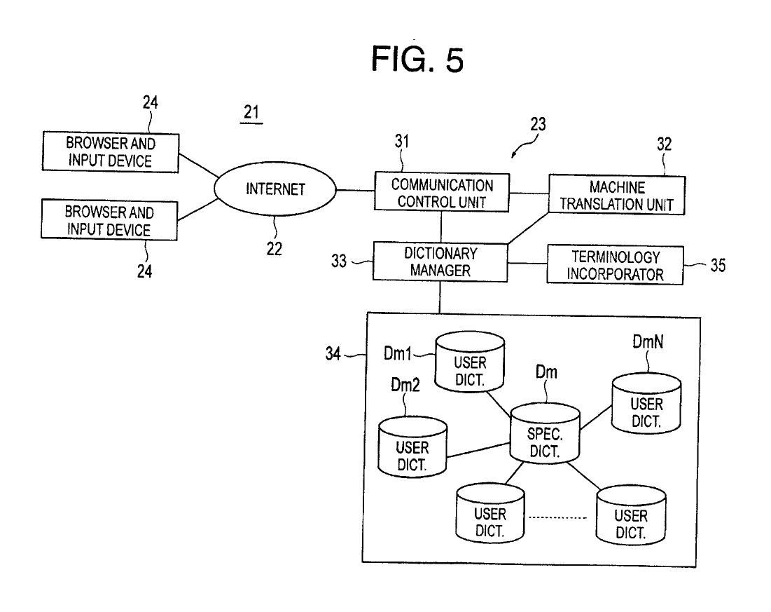

Next, an embodiment will be described in which the invented dictionary system is applied to a machine translation function provided in a server on the Internet. A machine translation network system in which this embodiment is applied can be represented as in FIG. 1, but its functional structure can be better represented as in FIG. 5.

The machine translation network system 21 in FIG. 5 resides on the Internet 22, comprising a retrieval and translation server 23 linked through the Internet 22 to a plurality of browser and input devices 24.

The browser and input devices 24, which are equivalent to the user terminal 4 in the preceding embodiment, submit document retrieval requests and translation requests to the Internet 22, display the retrieved documents or translations thereof, and submit new entries to be added to user dictionaries.

The retrieval and translation server 23 retrieves documents and executes various tasks, including machine translation of the documents. Its component elements include a communication control unit 31, a machine translation unit 32, a dictionary manager 33, a dictionary data base 34, and a terminology incorporator 35.

The communication control unit 31 (which includes functions of the HTTP daemon 10, log analyzer 11, communication tools 13a, translation processor 13b, and user registration and authentication unit 13d in FIG. 1) controls communication with the browser and input devices and an external Internet facility (not visible) that stores documents, enabling the retrieval and translation server 23 to retrieve documents from the external Internet facility and supply the retrieved documents or translations thereof to the browser and input devices 24.

The machine translation unit 32 (approximately equivalent to the machine translation system 14 in FIG. 1) translates a retrieved document into another language, when such translation is necessary. The machine translation unit 32 also controls dictionary usage.

The dictionary manager 33 (which includes functions of the dictionary editor 13c, community manager 13e, and dictionary converter 16 in FIG. 1) creates and edits dictionaries in the dictionary data base 34, and obtains word information from the dictionaries; that is, it obtains dictionary entries. For example, the dictionary manager 33 obtains the word information from a dictionary designated by the machine translation unit 32, and transfers the word information from the dictionary data base 34 to the machine translation unit 32. Similarly, the dictionary manager 33 obtains word information requested by the terminology incorporator 35 from a dictionary in the dictionary data base 34, and transfers the word information to the terminology incorporator 35. The terminology incorporator 35 may also designate an entry to be added to a dictionary, in which case the machine translation unit 32 adds the entry to the dictionary in the dictionary data base 34.

The dictionary data base 34 (approximately equivalent to the dictionary data base 15 in FIG. 1) is a data base storing a plurality of dictionaries in the tree structure described in the preceding embodiment. A general terminology dictionary occupies the root node of the tree, with specialized terminology dictionaries for broadly categorized fields or genres at the next hierarchical level; these broad fields or genres are then subdivided into more narrow categories with specialized terminology dictionaries at the next hierarchical level, and so on. The depth of the tree structure need not be uniform. The general terminology dictionary and each specialized terminology dictionary may have one or more user dictionaries attached to it. For simplicity, FIG. 5 shows only part of the tree structure, including one specialized terminology dictionary (SPEC. DICT.) Dm and its attached user dictionaries Dm1 to DmN, where N is a positive integer.

The terminology incorporator 35 automatically selects entries from the user dictionaries Dm1 to DmN that should be added to the specialized terminology dictionary Dm, and adds the selected entries to the specialized terminology dictionary Dm. This process may be carried out on a regular schedule, such as every day at 2:00 a.m., or it may be initiated by a system administrator of the retrieval and translation server 23 from an input-output device not shown in FIG. 5 (similar to the input-output device 18 in FIG. 1). The process may also be initiated whenever an entry is added to any user dictionary.

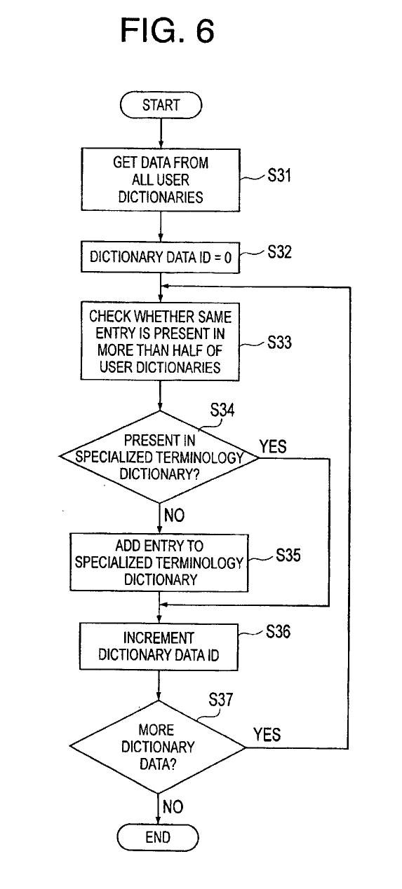

The operation of the terminology incorporator 35 in FIG. 5 will now be described with reference to FIG. 6, which illustrates the process applied to a single specialized terminology dictionary, either on a regular schedule or at the command of a system administrator as described above. The process is FIG. 6 is carried out for each specialized terminology dictionary separately.

When the process in FIG. 6 begins, the terminology incorporator 35 first extracts word information (entry data) from all of the user dictionaries attached to the specialized terminology dictionary being processed (step S31), and buffers the extracted information by storing it temporarily in the form of a table. During this step, the terminology incorporator 35 counts the number of occurrences of identical entries.

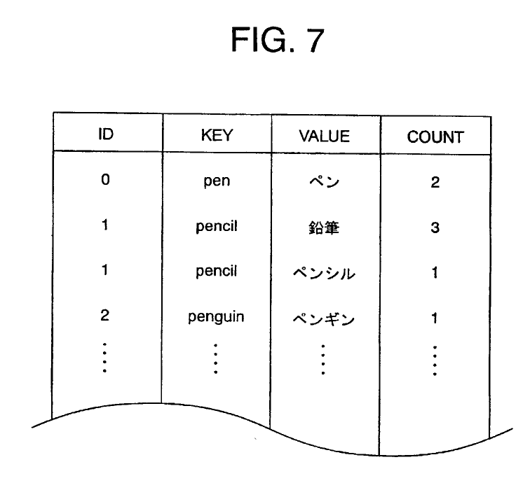

FIG. 7 shows an example of part of the entry data extracted from a set of English-to-Japanese user dictionaries attached to a certain specialized terminology dictionary. From left to right, the fields in the table are the dictionary data identification (ID) number, the English word or key, the Japanese translation of the key (the value of the key), and the number (count) of user dictionaries in which that particular Japanese translation appears. The word ‘pen’ was entered in two of the user dictionaries, both entries giving the same Japanese translation; this word is assigned dictionary data ID zero. The word ‘pencil’ (dictionary data ID=1) was entered in three user dictionaries giving one Japanese translation (read ‘enpitsu’), and one user dictionary giving another Japanese translation (read ‘penshiru’). The word ‘penguin’ (dictionary data ID=2) was entered in only one user dictionary.

After compiling a table like the one in FIG. 7, the terminology incorporator 35 initializes the dictionary data ID to zero (step S32 in FIG. 6). The succeeding steps (S33 to S37) form a loop that is repeated once for each dictionary data ID.

In steps S33 and S34, the terminology incorporator 35 determines whether the same entry appears in more than half of the attached user dictionaries, and if so, whether it is also present in the specialized terminology dictionary. If one or more entries, each appearing in more than half of the user dictionaries and not appearing in the specialized terminology dictionary, are found, they are all added to the specialized terminology dictionary (step S35). Then the dictionary data ID is incremented (step S36), and if the table compiled in step S31 includes any entries for the incremented dictionary data ID, the loop is repeated (step S37). When the end of the table is reached, the process ends.

If the number of user dictionaries is five, for example, then from the table in FIG. 7, the ‘pencil-enpitsu’ entry (occurring in three user dictionaries) is added to the specialized terminology dictionary.

The process in FIG. 6 can be modified in various ways. For example, the criterion for adding an entry to the specialized terminology dictionary can be changed from occurrence in more than half of the user dictionaries to occurrence in at least a fixed threshold number of user dictionaries.

An extra step may be added to the process to delete an entry from the user dictionaries after it has been added to the specialized terminology dictionary.

Since the number of attached user dictionaries may be very large, the process may be restricted to a predetermined set of user dictionaries for each specialized terminology dictionary. For example, the terminology incorporator 35 may examine only the one hundred attached user dictionaries having the most entries. Alternatively, the terminology incorporator 35 may examine only user dictionaries having at least a predetermined threshold number of entries, or may examine a randomly selected subset of user dictionaries, or may use a combination of these methods to select the user dictionaries from which entries are compiled in step S31.

The process in FIG. 6 is completely automatic, but it may be modified by adding a step in which entries selected in steps S33 and S34 are submitted to the system administrator or other competent personnel for confirmation before being added to the specialized terminology dictionary.

If user dictionaries are attached to the general terminology dictionary, the same process may be used to add entries to the general terminology dictionary.

The process in FIG. 6 improves the quality of machine translation results by automatically enabling the machine translation unit 32 to adopt translations that are used by a large number of users. Users who do not create extensive user dictionaries benefit particularly from this ability of the system to incorporate the wisdom of other users.

For the system administrator (or server administrator), a further benefit is that the completeness requirements applied to the original versions of the specialized terminology dictionaries can be relaxed, because as the system operates, these dictionaries will be gradually filled out with the accumulated knowledge of the community of users. The system administrator can thus put the machine translation system into operation without first going to the considerable time and expense of constructing a set of highly complete specialized terminology dictionaries.

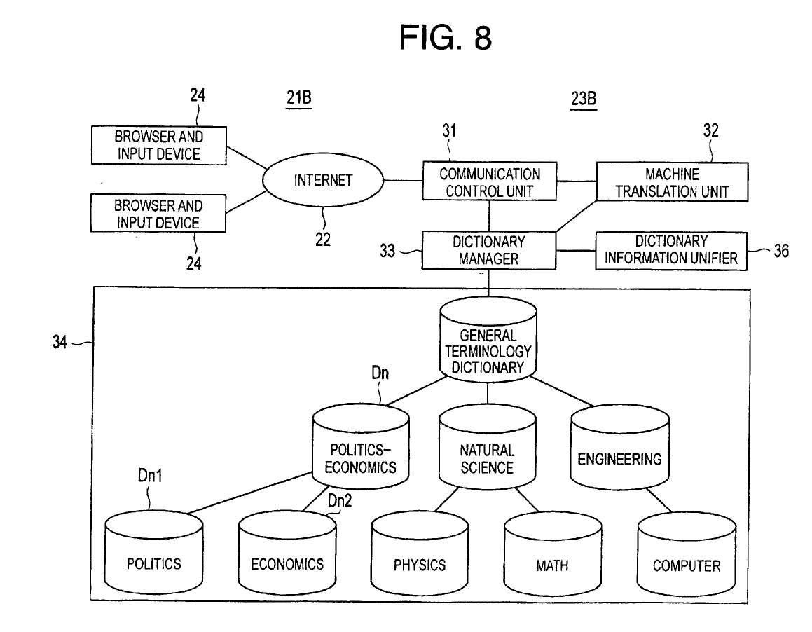

FIG. 8 shows another embodiment of the first aspect of the invention in which the invented dictionary apparatus is applied to a machine translation function provided in a server on the Internet. This embodiment is a machine translation network system 21A having substantially the same structure as in FIG. 5, except that the terminology incorporator is replaced by a dictionary information unifier 36. Because of this difference, the retrieval and translation server 23A in this embodiment operates differently from the retrieval and translation server 23 in the preceding embodiment.

The dictionary data base 34 in this embodiment is similar to the dictionary data base 34 in the preceding embodiment, but for explanatory purposes, FIG. 8 shows an example of a tree of specialized terminology dictionaries, omitting the attached user dictionaries. Three of the specialized terminology dictionaries in this tree are a politics dictionary Dn1 and an economics dictionary Dn2, and a politics-economics dictionary Dn disposed just above dictionaries Dn1 and Dn2 in the tree structure. Dictionary Dn is also referred to as the parent dictionary of dictionaries Dn1 and Dn2.

From time to time, the dictionary information unifier 36 examines the specialized terminology dictionaries and shifts common entries upward in the tree structure, from subordinate dictionaries to a common parent dictionary. For example, an entry occurring in both the politics dictionary Dn1 and the economics dictionary Dn2 is shifted from these dictionaries into the politics-economics dictionary Dn. This process may be carried out automatically on a regular schedule (daily at 2:00 a.m., for example), or it may be initiated by the system administrator of the retrieval and translation server 23A from an input-output device not shown in the drawings (equivalent to the input-output device 18 in FIG. 1).

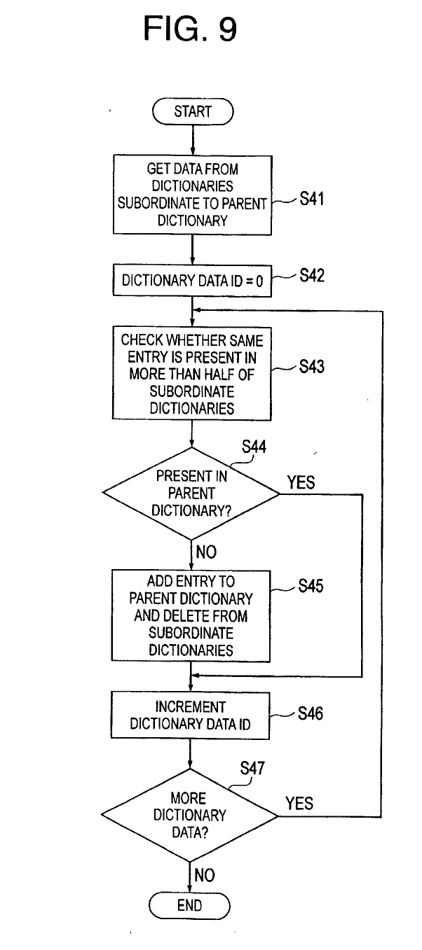

The operation of the dictionary information unifier 36 will now be described in more detail with reference to FIG. 9. For simplicity, FIG. 9 shows only the addition of entries to a single parent dictionary, such as the politics-economics dictionary Dn in FIG. 8. The same process is carried out for all specialized terminology dictionaries in the tree structure, except for the specialized terminology dictionaries located at the leaf nodes in the tree structure.

The process begins with the reading of all entries from all specialized terminology dictionaries immediately subordinate to the parent dictionary being processed (step S41). These entries are compiled into a table similar to the one shown in FIG. 7, in which words are identified by dictionary data IDs.

After compiling this table, the dictionary information unifier 36 initializes the dictionary data ID to zero (step S42 in FIG. 9). The succeeding steps (S43 to S47) form a loop that is repeated once for each dictionary data ID.

In steps S43 and S44, the dictionary information unifier 36 determines whether the same entry appears in more than half of the immediately subordinate specialized terminology dictionaries, and if so, whether it is also present in the parent dictionary. If one or more entries, each appearing in more than half of the subordinate specialized terminology dictionaries and not appearing in the parent dictionary, are found, they are all added to the parent dictionary and deleted from the subordinate dictionaries (step S45). Then the dictionary data ID is incremented (step S46), and if the table compiled in step S41 includes any entries for the incremented dictionary data ID, the loop is repeated (step S47). When the end of the table is reached, the process ends.

The process in FIG. 9 may be carried out on the specialized terminology dictionaries one by one, working from the bottom of the tree structure toward the top, so that entries that have propagated from one level in the tree to the next-higher level can then propagate to still higher levels.

The process in FIG. 9 can be modified in various ways. For example, the criterion for adding an entry to the parent dictionary can be changed from occurrence in more than half of the subordinate specialized terminology dictionaries to occurrence in at least a fixed threshold number of subordinate specialized terminology dictionaries. The retrieval and translation server 23A may also monitor the usage of the terms in each specialized terminology dictionary, and add terms to a parent dictionary only if they occur in a plurality of subordinate specialized terminology dictionaries and meet predetermined criteria for frequency or rate of usage.

Step S45 may be modified so that the entries added to the parent dictionary are also left in the subordinate dictionaries.

The process in FIG. 9 is completely automatic, but it may be modified by adding a step in which entries selected in steps S43 and S44 are submitted to the system administrator or other competent personnel for confirmation before being added to the parent dictionary.

The same process may be used to add entries to the general terminology dictionary at the top of the tree.

The process in FIG. 9 improves the quality of translation of documents not belonging to highly specialized fields or genres by increasing the content of the dictionaries used to translate those documents.

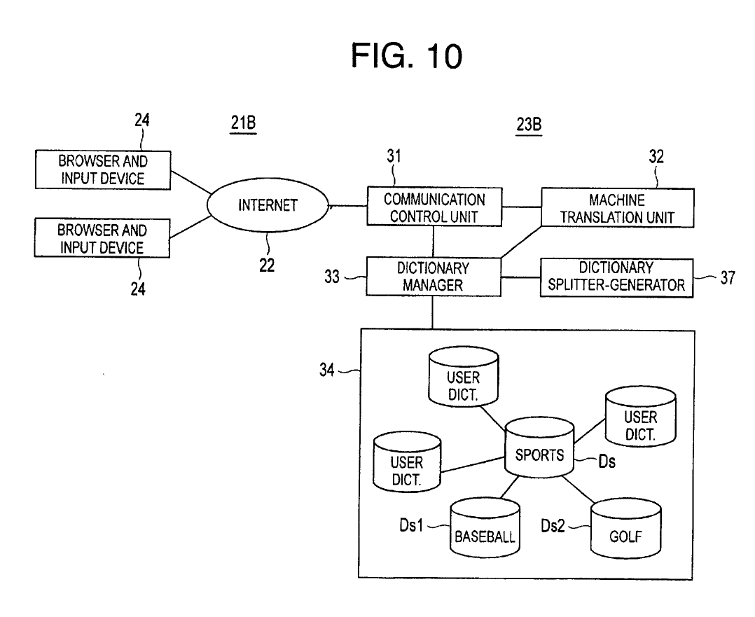

FIG. 10 shows yet another embodiment of the first aspect of the invention in which the invented dictionary apparatus is applied to a machine translation function provided in a server on the Internet. This embodiment is a machine translation network system 21B having substantially the same structure as in FIG. 5, except that the terminology incorporator is replaced by a dictionary splitter-generator 37. Because of this difference, the retrieval and translation server 23B in this embodiment operates differently from the retrieval and translation server in the preceding embodiments.

The dictionary data base 34 in this embodiment is similar to the dictionary data base 34 in FIG. 5. For simplicity, FIG. 10 shows only a specialized English-to-Japanese sports terminology dictionary Ds, its attached user dictionaries, and two subordinate dictionaries Ds1, Ds2 dealing with baseball and golf, respectively.

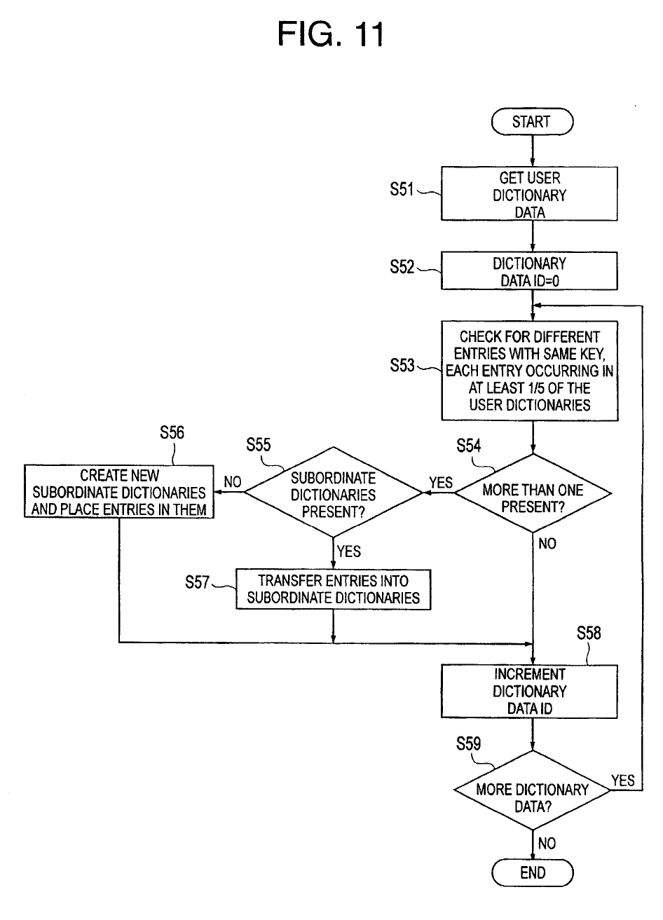

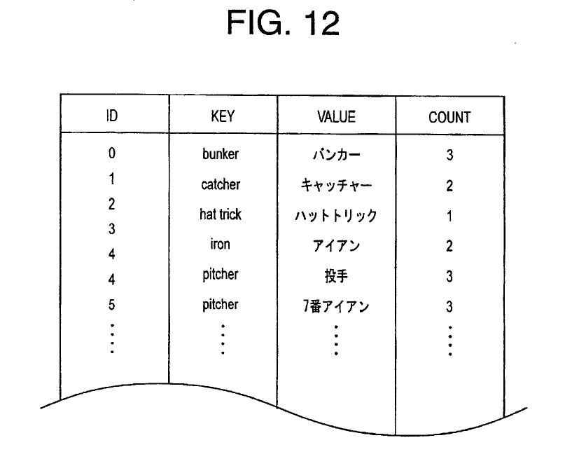

The dictionary splitter-generator 37 is activated on a regular schedule (on the first day of each month, for example). Alternatively, the dictionary splitter-generator 37 may be activated by the system administrator of the retrieval and translation server 23B from an input-output device not shown in the drawings (equivalent to the input-output device 18 in FIG. 1). The process performed by the dictionary splitter-generator 37 will be described below with reference to FIGS. 11 and 12. For simplicity, these drawings illustrate only the processing of the English-to-Japanese sports dictionary Ds.

The process begins with the reading of entry information from all of the attached user dictionaries (step S51 in FIG. 11). The information is compiled into a table like the one shown in FIG. 12. From left to right, the fields in the table are the dictionary data ID, the English word or key, the Japanese translation or value, and the number of user dictionaries giving that translation of the key.

When this table has been compiled, the dictionary data ID is initialized to zero (step S52). The succeeding steps (S53 to S59) form a loop that is repeated once for each key, that is, once for each dictionary data ID.

In steps S53 and S54, the dictionary splitter-generator 37 ascertains whether the key has more than one translation that appears in at least, for example, one-fifth of the attached user dictionaries. If this is the case (‘yes’ in step S54), the dictionary splitter-generator 37 ascertains whether there are any specialized terminology dictionaries subordinate to the specialized terminology dictionary being processed (step S55).

If there are no subordinate specialized terminology dictionaries, the dictionary splitter-generator 37 creates one new subordinate specialized terminology dictionary for each different translation of the key that appears in at least one-fifth of the user dictionaries, and enters the key and the corresponding translations in these dictionaries (step S56). These new dictionaries may be created on a provisional basis. The user dictionaries in which the key and its translations appear may remain attached to the parent dictionary (the specialized terminology dictionary being processed), or may be reattached to the newly created subordinate specialized terminology dictionaries.

If subordinate specialized terminology dictionaries already exist, the dictionary splitter-generator 37 selects appropriate ones of these subordinate specialized terminology dictionaries and transfers the key and its translations into them (step S57). The transfer may be provisional. The user dictionaries in which the key and its translations appear may remain attached to the parent dictionary, or may be reattached to the subordinate specialized terminology dictionaries into which the corresponding definitions are transferred.

The subordinate specialized terminology dictionaries are selected on the basis of, for example, the occurrence of the translation as a key in another specialized terminology dictionary (e.g., a specialized Japanese-to-English terminology dictionary), enabling the field or genre of the translation to be recognized, or the occurrence of a character string containing part of all of the translation in another entry in the subordinate specialized terminology dictionary.

After the multiple definitions appearing in at least one-fifth of the user dictionaries have been transferred into subordinate specialized terminology dictionaries in step S56 or S57, or if there is not more than one such definition (‘no’ in step S54), the dictionary data ID is incremented (step S58) If the table compiled in step S51 includes any entries for the incremented dictionary data ID, the loop is repeated (step S59). When the end of the table is reached, the process ends.

It is difficult to automate the creation of new specialized terminology dictionaries completely, so the process in FIG. 11 may be followed by post-processing by a person operating the retrieval and translation server 23B, referred to below as a system operator. If new specialized terminology dictionaries have been created, the system operator may supply category names for the fields or genres of the new dictionaries. If new specialized terminology dictionaries have been created provisionally in step S56, the system operator may decide whether the new dictionaries are necessary or not, and retain or discard them accordingly. If a newly created dictionary is retained, the system operator may transfer other entries into it from the parent dictionary above it. If definitions have been transferred provisionally in step S57, the system operator may decide whether to finalize the transfer, or leave the definitions in their original locations.

For example, if there are ten user dictionaries attached to the sports dictionary Ds, then the two different entries for the word ‘pitcher’ in FIG. 12 qualify for transfer to subordinate specialized terminology dictionaries or inclusion in new specialized terminology dictionaries, since each entry occurs in three of the ten user dictionaries. One definition (read ‘toshu’) is a baseball term. The other definition (read ‘7-ban aian’) is a golf term. If the sports dictionary has no subordinate specialized terminology dictionaries, the dictionary splitter-generator 37 creates one new subordinate dictionary to hold the ‘pitcher; toshu’ definition, and another to hold the ‘pitcher; 7-ban aian’ definition. The system operator may name the first of these new dictionaries the baseball dictionary, and the second the golf dictionary, thereby creating the dictionary tree structure shown in FIG. 10.

If the sports dictionary Ds already has a subordinate baseball dictionary Ds1 and a subordinate golf dictionary Ds2, the ‘pitcher; toshu’ entry may be moved into the baseball dictionary on the basis of the presence of related terms such as ‘right fielder; uyokushu’ in that dictionary Ds1. Similarly, the ‘pitcher; 7-ban aian’ entry may be moved into the golf dictionary Ds2 on the basis of the presence of related terms such as ‘iron: aian’ in that dictionary Ds2.

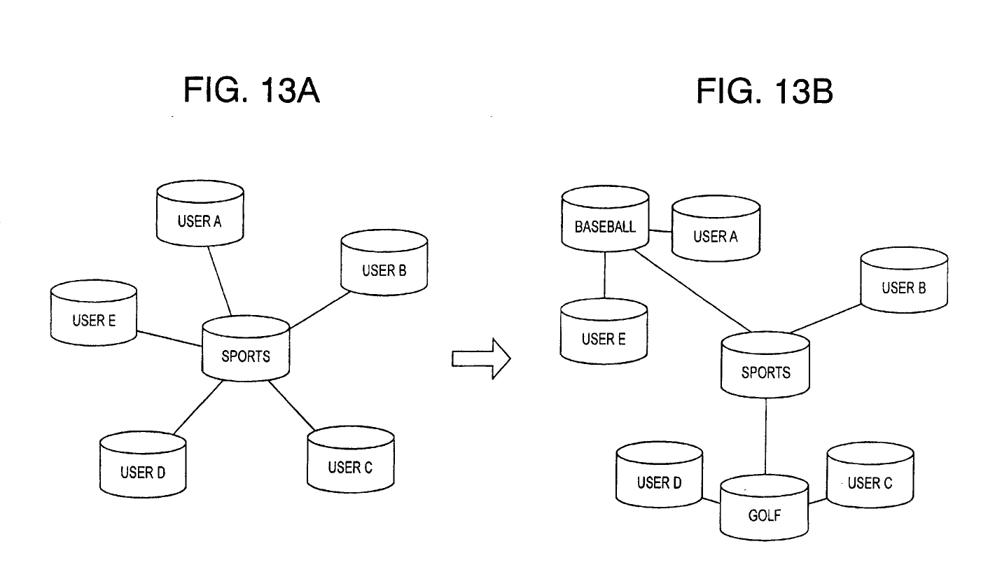

FIGS. 13A and 13B illustrate the operation described above under the assumption that the sports dictionary originally had no subordinate specialized terminology dictionaries. FIG. 13A shows the original sports dictionary with five attached user dictionaries. The process in FIG. 11 and the associated post-processing add a subordinate baseball dictionary, reattach user dictionaries A and E thereto, add a subordinate golf dictionary, and reattach user dictionaries C and D thereto, as shown in FIG. 13B.

The process in FIG. 11 can be modified in various ways. For example, the decision as to whether or not to create a new subordinate specialized terminology dictionary can be based on both the entries in the attached user dictionaries and the entries in the specialized terminology dictionary being processed, instead of only being based on the entries in the user dictionaries. A new subordinate specialized terminology dictionary can then be created if a key appears with one translation in the specialized terminology dictionary being processed, and with a different translation in at least a predetermined number of attached user dictionaries, or at least a predetermined percentage of the attached user dictionaries.

In another modification, new subordinate specialized terminology dictionaries can be created even when a subordinate specialized terminology dictionary is already present. For example, even if a judo dictionary and a track-and-field dictionary are already present in the level just below the sports dictionary, a new baseball dictionary and a new golf dictionary can be added at this level if entries such as ‘pitcher; toshu’ and ‘pitcher; 7-ban aian’ are found in a sufficient number of user dictionaries attached to the sports dictionary.

The criterion for adding new entries to specialized terminology dictionaries can be changed from occurrence in one-fifth of the attached user dictionaries, as mentioned above, to occurrence in a different proportion of the user dictionaries, or occurrence in at least a predetermined threshold number of user dictionaries.

The post-processing described above need not be carried out by a system operator. It can also be carried out by, for example, majority vote among a group of users. Voting can be done by electronic mail, or by having users vote voluntarily on an electronic bulletin board.

The effect of the process in FIG. 11 is that information contributed by individual users in their user dictionaries can be used to construct specialized terminology dictionaries that become available to all users of the system. Users can then obtain high-quality translations of Web pages in a wide range of fields or genres without having to create and maintain extensive user dictionaries themselves in all of these fields or genres.

Post-processing similar to that described for the retrieval and translation server 23B in FIG. 10 can also be used in the retrieval and translation server 23 in FIG. 5 and the retrieval and translation server 23A in FIG. 8. That is, the final decision on whether to transfer entries from one dictionary to another in those embodiments can be made subject to the judgment of a system operator or a group of users.

Needless to say, the system operator may edit or reconfigure the specialized terminology dictionaries in the retrieval and translation servers 23, 23A, 23B directly. Users may also be permitted to edit these dictionaries.

The features of the retrieval and translation servers 23, 23A, and 23B may be combined in a single retrieval and translation server.

The retrieval and translation server 23, 23A, or 23B need not be located on a server on the Internet, but can be used in any machine translation system having a dictionary tree structure of the general type described in FIG. 2, including a system that is shared by several users at a single location.

Furthermore, use of this dictionary tree structure is not limited to machine translation systems; the same structure can be usefully employed in other types of natural-language processing systems, including speech recognition systems and systems for converting text entered from a keyboard into Japanese kanji or other characters that cannot be entered directly.

The first aspect of the present invention can thus be used to improve the quality of a variety of types of natural-language processing, and to make the dictionaries needed in such processing easier to construct.

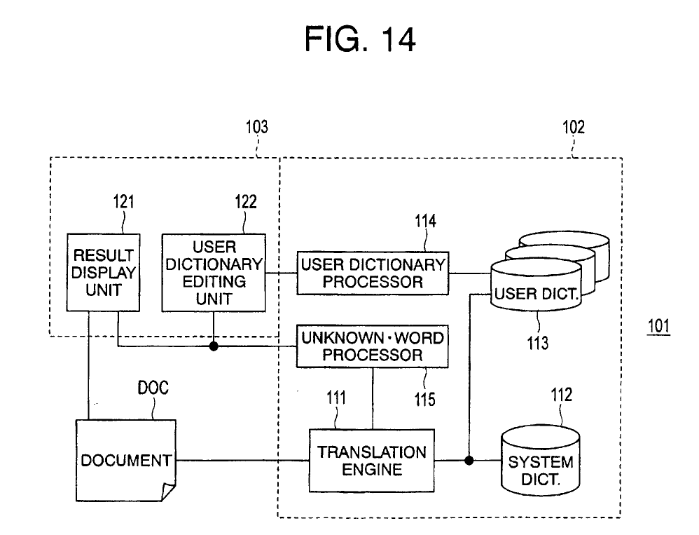

As an embodiment of the second aspect of the invention, FIG. 14 shows a block diagram of a machine translation system 101 comprising a translation processing section 102 and a display section 103. The translation processing section 102 and display section 103 may be parts of a single information-processing system, or parts of separate information-processing systems linked by a network such as the Internet. The translation processing section 102 may be centralized on a single server apparatus, or distributed over two or more servers. The display section 103, at least, is located where it can be operated by a user of the system.

The translation processing section 102 comprises a translation engine 111, at least one system dictionary (DICT.) 112, a plurality of user dictionaries 113, a user dictionary processor 114, and an unknown-word processor 115.

The translation engine 111 translates an input source document (DOC) from the source language of the document to a target language, using information stored in the system dictionary 112 and user dictionaries 113, and thereby generates a translated document (the translation result). If the source document includes words that the translation engine 111 is unable to translate, these words are indicated as unknown words in the translated document. For example, unknown words may appear in the source language in the translated document.

The source document (DOC) may be submitted in any form. For example, the source document may be typed in from a keyboard attached to the translation processing section 102, read from a floppy disk, a compact disc read-only memory (CD-ROM) or other machine-readable media, or transmitted to the translation processing section 102 from another apparatus, which may be disposed at a remote location. If the translation processing section 102 is connected to the Internet, for example, users may submit Web pages that they have retrieved from other servers on the Internet.

The system dictionary 112 is prepared by the provider of the machine translation system 101. The user dictionaries 113 belong to individual users or groups of users of the machine translation system 101, and store key and value information entered by the users themselves. Even if the system dictionary 112 resides in a personal computer with only one user, there may be multiple user dictionaries 113 that are used for different purposes, or in different specialized fields, a designated subset of the user dictionaries 113 being used for each translation task.

The user dictionary processor 114 updates the information stored in the user dictionaries 113. This process will be described in more detail later.

The unknown-word processor 115 receives each translation result from the translation engine 111, determines whether the translation result includes any unknown words, and sends the translation result to the display section 103. If the translation result includes unknown words, the unknown-word processor 115 also collects the unknown words and sends a list of these words as unknown-word information to the display section 103. The unknown-word processor 115 may also receive the source document from the translation engine 111 and send source-document information to the display section 103.

The display section 103 comprises a result display unit 121 and a user dictionary editing unit 122. The display section 103 also includes input devices (not visible) such as a keyboard and a mouse or other pointing device.

The result display unit 121 is at least capable of displaying the translation result, and may also be capable of displaying the source document, which may be obtained either directly (as indicated) or from the unknown-word processor 115 in the translation processing section 102.

The user dictionary editing unit 122 receives unknown-word information from the unknown-word processor 115, generates a display for editing the user dictionaries 113, obtains user-dictionary editing information, and sends the user-dictionary editing information to the user dictionary processor 114. The initial display generated just after the unknown-word information is received includes all of the unknown words, displayed in the source language.

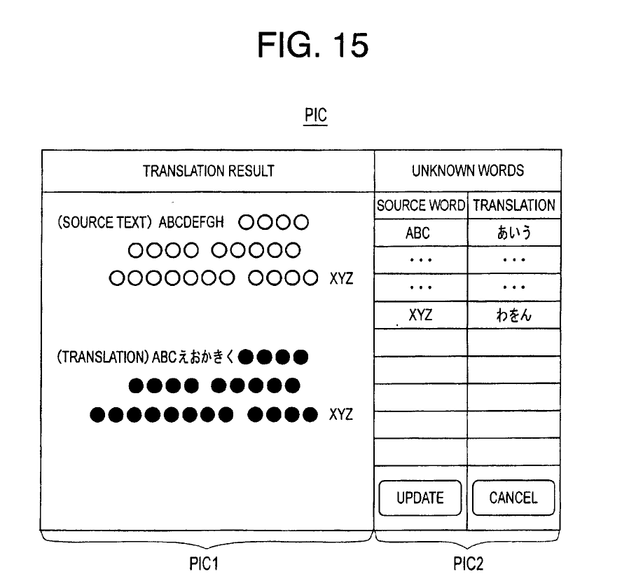

FIG. 15 shows an example of the display screen (PIC) of the display section 103. The screen is divided into a first area (PIC1) for display of the translation result by the result display unit 121, and a second area (PIC2) for use by the user dictionary editing unit 122 in editing the user dictionaries 113. The second area (PIC2) includes input fields for entry of new vocabulary. In FIG. 15, the input fields comprise a column of source word fields and an adjacent column of translation fields, but additional fields may be provided, such as fields for designating the part of speech and the relevant dictionary, and check boxes for designating the word pairs that are actually to be entered. There may also be an ‘update’ button, a ‘cancel’ button, and various icons (not visible) that the user can select with the pointing device of the display section 103.

FIG. 15 shows the display screen after the user has entered translations for the unknown words. In the initial display, just after the unknown-word information was received from the user dictionary editing unit 122, the ‘translation’ column in the PIC2 area would be empty. In FIG. 15, the first word ABC and last word XYZ of the source document are among the unknown words; the known words have been translated into Japanese. For simplicity, some of the source-language words are indicated by white circles, and some of the Japanese words by black circles.

If the user dictionary editing unit 122 does not receive any unknown-word information from the unknown-word processor 115, the second area PIC2 need not be displayed, but it may be displayed anyway, to enable the user to enter new translations for words after seeing the translation result.

The user dictionary editing unit 122 allows the user to enter and delete words in both the source language and the target language until the user clicks on the ‘update’ button. When the user clicks on the update button, the user dictionary editing unit 122 sends the user-dictionary editing information to the user dictionary processor 114. Further description of the input process will be omitted, as input methods are well known.

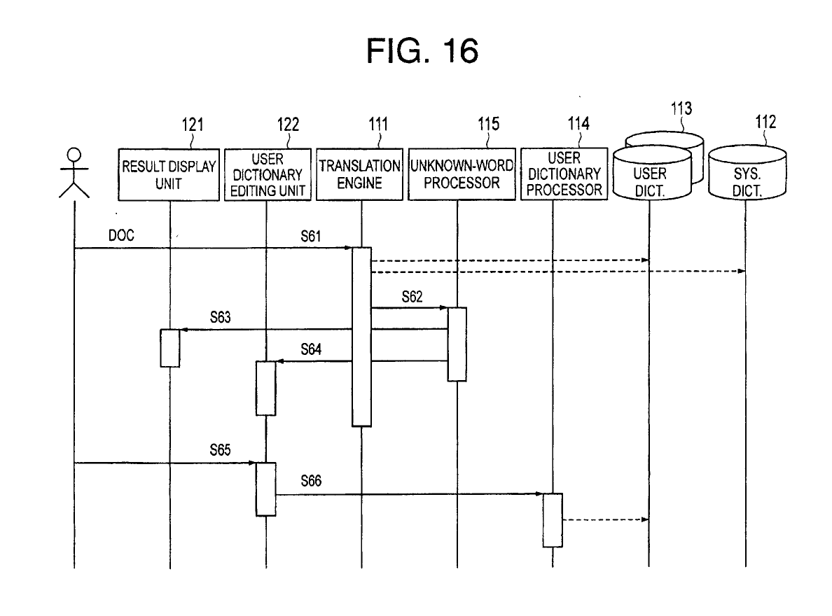

The operation of the machine translation system 101 is illustrated in FIG. 16.

When the user submits a document (DOC) to be translated, the translation engine 111 uses the user dictionaries 113 and system dictionary (SYS. DICT.) 112 to carry out the translation process (step S61), and sends at least the translation result to the unknown-word processor 115 (step S62).

The unknown-word processor 115 collects the unknown words from the translation result (from the translated document), sends the translation result (the translated document) to the result display unit 121 to be displayed in the first area (PIC1) of the screen (step S63), and sends the list of collected unknown words to the user dictionary editing unit 122 to be displayed in the second area (PIC2) of the screen, for use in editing the user dictionaries 113 (step S64). Depending on the source and target languages, unknown words can be collected from the translation result by searching for character strings including characters from the source language, or the translation engine 111 may provide explicit indications as to which words are unknown.

The user now sees a display like the one in FIG. 15, except that the ‘translation’ column in the second area (PIC2) is blank. Besides reading the translation result, at the prompting of the user dictionary editing unit 122, the user enters translations for any of the unknown words that he can translate (step S65). If the user is dissatisfied with the translation result, he may enter other words that were poorly translated in the unknown-words column, and enter the desired translations in the translation column.

When the user finishes entering translations of unknown words and clicks on the ‘update’ button, the user dictionary editing unit 122 sends the information entered by the user to the user dictionary processor 114, which proceeds to update the relevant user dictionary 113 or dictionaries (step S66). After completing the update, the user dictionary processor 114 may notify the translation engine 111 and have the source document retranslated, using the updated user dictionaries 113.

By collecting a list of unknown words and generating a dictionary-editing display, the machine translation system 101 enables the user to update user dictionaries 113 in a very convenient way, while seeing the translation result, without having to change modes. From the viewpoint of the system, it is also efficient for the user dictionary processor 114 to receive a batch of user-dictionary editing information and perform all of the concomitant editing of the user dictionaries 113 at one time.

Particularly when the user is confronted by a long translated document including many unknown words, it is much easier for the user to work from a list, as described above, than to have to enter unknown words and their translations as he encounters them while reading the translated document, as in conventional systems.

In a variation of this embodiment, when the user dictionary editing unit 122 receives unknown-word information from the unknown-word processor 115, it first generates an icon on the display screen, and generates the dictionary-editing display (PIC2) only when the user clicks on the icon. The icon may by labeled with a legend such as ‘Unknown words’ or ‘Dictionary update.’

In another variation, the display section 103 generates the dictionary-editing display on request from the user, at a time independent of the time of display of the translation result. In this case, as the display section 103 receives lists of unknown words from the unknown-word processor 115, it stores them until the user gives a dictionary-editing command. In this way, the user can view a series of translated documents, then enter translations of unknown words from all of the documents in a single operation at a convenient time.

The system may allow the user to select the timing of the dictionary update before requesting a translation, and generate the dictionary-editing display in parallel with the translation-result display only if the user requests this in advance.

In yet another variation, the unknown-word processor 115 is disposed in the display section 103 instead of the translation processing section 102. This variation enables the invention to be practiced in a network using conventional translation servers, for example.

In still another variation, when the user supplies a translation for an unknown word, the user dictionary processor 114 may enter the supplied information both in a user dictionary employed for translating from the source language to the target language, and in a user dictionary employed for translation from the target language to the source language.

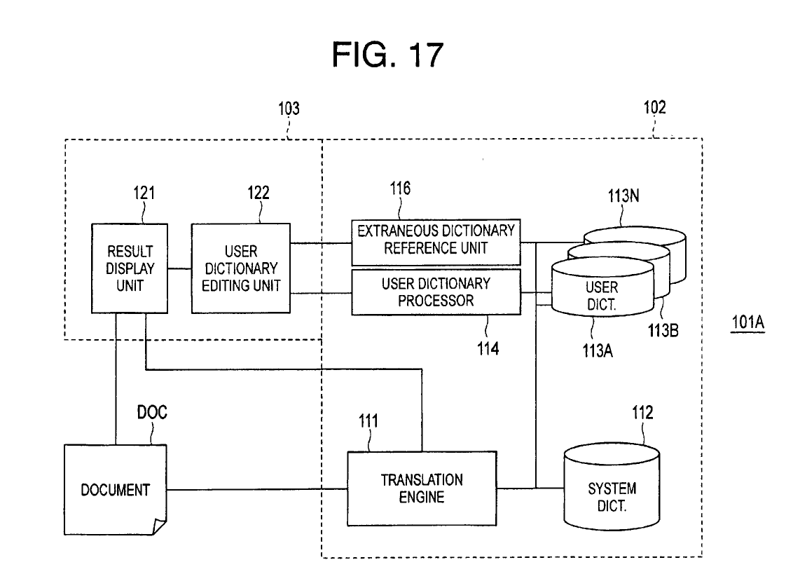

FIG. 17 shows another machine translation system 101A illustrating the second aspect of the invention. This machine translation system 101A also comprises a translation processing section 102 and a display section 103.

The translation processing section 102 comprises a translation engine 111, a system dictionary 112, user dictionaries 113A to 113N, a user dictionary processor 114, and an extraneous dictionary reference unit 116. The translation processing section 102 receives source documents from a plurality of users, each of whom has his or her own user dictionary. In the following description it will be assumed that a source document (DOC) is received from the user who maintains user dictionary 113A.

The extraneous dictionary reference unit 116 receives (unknown) words from the user dictionary editing unit 122 with a request to search for them in other users' user dictionaries 113B to 113N, which were not used in the translation of the source document (DOC). The extraneous dictionary reference unit 116 extracts entries for these words from those user dictionaries, and sends the extracted information to the user dictionary editing unit 122.

The other elements in the translation processing section 102 are similar to the corresponding elements in the preceding embodiment.

The display section 103 comprises a result display unit 121 and a user dictionary editing unit 122, which differ as follows from the corresponding elements in the preceding embodiment.

The result display unit 121 receives a translation result directly from the translation engine 111 in the translation processing section 102, recognizes unknown words in the translation result, and displays the translation result with the unknown words placed in a clickable state: for example, tagged with markup symbols such that if the user clicks on one of these words, the user dictionary editing unit 122 responds as described below. The result display unit 121 also sends the user dictionary editing unit 122 a request to generate the dictionary-editing display described in the preceding embodiment.

The user dictionary editing unit 122 generates this display and sends user-dictionary editing information to the user dictionary processor 114. In addition, when the user clicks on an unknown word in the translation result, the user dictionary editing unit 122 sends the extraneous dictionary reference unit 116 a request for information about this word from other user dictionaries, and generates a candidate translation display comprising any translations of the unknown word that the extraneous dictionary reference unit 116 finds in the other user dictionaries and sends back. If the user clicks on one of these candidate translations, the user dictionary editing unit 122 transfers the selected translation to the ‘translation’ column in the dictionary-editing display.

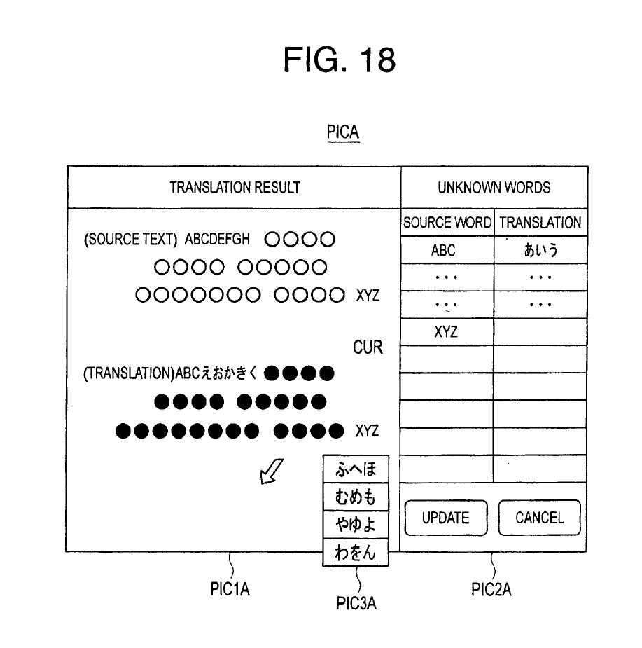

FIG. 18 shows an example of a display (PICA) produced by the display section 103 in FIG. 17. The display includes a first area (PIC1A) in which the translation result is displayed, a second area (PIC2A) in which dictionary-editing information is displayed, and a third area (PIC3A) in which candidate translations are displayed. In this example, the user has selected the last word XYZ, which is an unknown word, with the pointing device, as indicated by the position of an arrow cursor (CUR), and pressed the necessary key or button to click on this word. The user dictionary editing unit 122 has displayed four candidate translations of this word. If the user clicks on one of the four candidate words, the user dictionary editing unit 122 enters the selected word in the translation column in the second area PIC2A, beside the unknown word XYZ.

The user dictionary editing unit 122 also generates a candidate translation display (PIC3A) if the user clicks on a source word or a corresponding empty field in the second display area PIC2A.

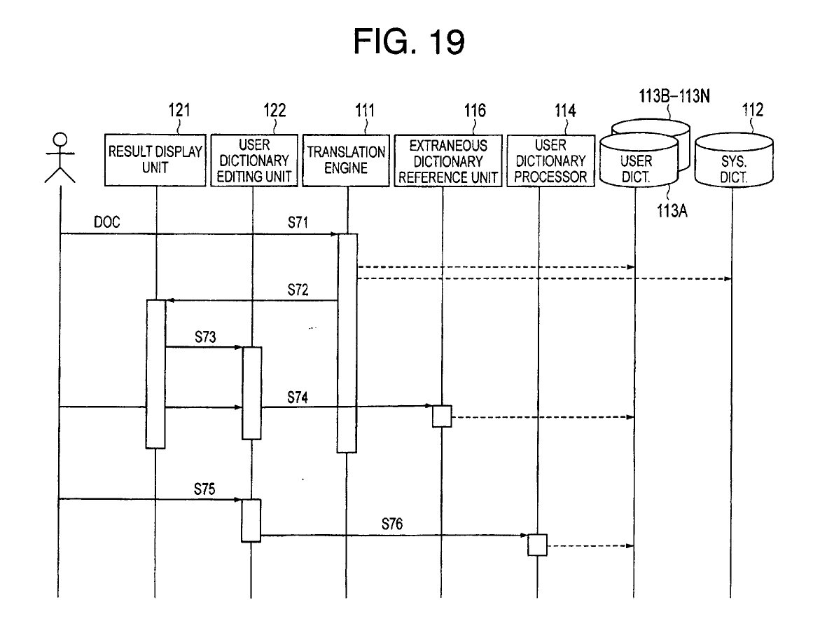

FIG. 19 illustrates the operation of the machine translation system 101A in FIG. 17.

When the user submits a document (DOC) to be translated, the translation engine 111 uses the system dictionary 112 and user dictionary 113A to carry out the translation process (step S71), and sends the translation result to the result display unit 121 (step S72).

The result display unit 121 displays the translation result in the first screen area PIC1A, placing unknown words in a clickable state, and the user dictionary editing unit 122 displays the unknown words in the second screen area PIC2A (step S73). Although the unknown words are recognized by a different entity (the result display unit 121) in this embodiment, the method by which the unknown words are recognized may be the same as in the preceding embodiment. For example, if the source language and target language have different character sets, unknown words can be recognized as character strings belonging to the source-language character set.

When the user clicks on an unknown word, the user dictionary editing unit 122 sends this word to the extraneous dictionary reference unit 116, to be looked up in other users' dictionaries (step S74). The extraneous dictionary reference unit 116 sends back any candidate translations obtained from the other user dictionaries 113B to 113N. The user dictionary editing unit 122 displays a list of the candidate translations, if any are found. The user then enters a translation for the unknown word, either from the keyboard or by selecting one of the candidate translations (step S75).

When the user clicks on the ‘update’ button, the user dictionary editing unit 122 sends user-dictionary editing information, including the translations selected by the user, to the user dictionary processor 114, which proceeds to update user dictionary 113A (step S76).

A Being able to refer to other users' user dictionaries greatly simplifies the task of entering translations for unknown words, especially when the user does not know the d meaning of the unknown word. Copying translations from one user dictionary to another in this way also reduces typing mistakes.

This embodiment can be altered in various ways. For example, any of the variations of the machine translation system 101 in FIG. 14, described in the preceding embodiment, can be applied to the machine translation system 101A in FIG. 15, with suitable modifications.

In another variation, the user dictionary editing unit 122 displays candidate translations, obtained from the extraneous dictionary reference unit 116, in the initial dictionary-editing screen. Colors may be used to distinguish these initial candidate translations from translations selected or entered by the user.

In another variation, the translation engine 111 in the translation processing section 102 sends unknown words to the extraneous dictionary reference unit 116, receives candidate translations from other users' dictionaries, and sends these candidate translations to the display section 103 together with the translation result. The user dictionary editing unit 122 can then display the candidate translations as soon as they are requested by the user, without having to query the user dictionary processor 114.

In another variation, the extraneous dictionary reference unit 116 operates whenever the user edits his or her user dictionary 113A, even if the editing is independent of the translation of any particular document. For example, the user may enter a word from the keyboard, have the system display a list of candidate translations collected from other users' dictionaries 113B to 113N, then have one of the candidate translations copied into the user's own dictionary 113A.

In another variation, when searching for candidate translations, the extraneous dictionary reference unit 116 looks in both directions. That is, besides searching in other users' dictionaries that are used for translation from the source language to the target language, it searches in dictionaries used for translation from the target language to the source language, to see if the unknown word is listed as a translation of some target-language word.

In another variation, the extraneous dictionary reference unit 116 searches not only in other users' dictionaries, but also in specialized dictionaries belonging to the user himself, which were not used in translating the document because they pertained to other fields or genres.

In another variation, the same technique is used to assist the system operator in editing the system dictionary 112.

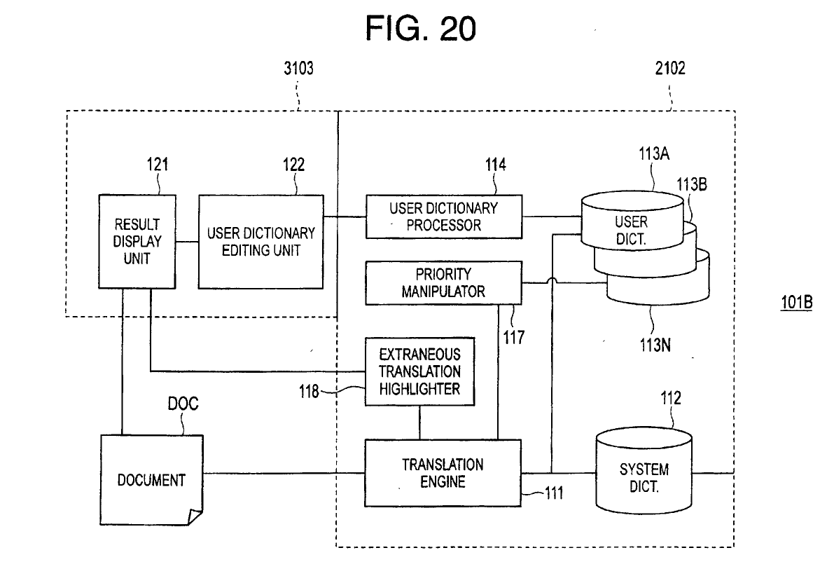

FIG. 20 shows another machine translation system 101B embodying the second aspect of the invention. This embodiment also comprises a translation processing section 102 and a display section 103.

The translation processing section 102 comprises a translation engine 111, a system dictionary 112, user dictionaries 113A to 113N, a user dictionary processor 114, a priority manipulator 117, and an extraneous translation highlighter 118. The system dictionary 112, user dictionariess 113A to 113N, and user dictionary processor 114 are similar to the corresponding elements in the preceding embodiments. The user dictionaries 113A to 113N belong to different users of the system. In the description below, the document (DOC) to be translated is submitted by the user who owns user dictionary 113A.

The translation engine 111 operates as described in the preceding embodiments, except that when translating the submitted document (DOC), it uses both the user dictionary 113A of the submitting user and the user dictionaries 113B to 113N of other users. When forced to use a translation taken from one of these other user dictionaries 113B to 113N, the translation engine 111 notifies the extraneous translation highlighter 118.

The priority manipulator 117 determines the priority order of the dictionaries used by the translation engine 111. Normally, the user dictionary 113A belonging to the user who submits the document to be translated has the highest priority, the system dictionary 112 has the next-highest priority, and the other user dictionaries 113B to 113N have lower priorities. In other words, the translation engine 111 uses the other user dictionaries 113B to 113N only to look up words for which no translation is given in user dictionary 113A and the system dictionary 112. The priority manipulator 117 is necessary because documents to be translated may be submitted by different users of the system.

The extraneous translation highlighter 118 operates together with the translation engine 111. When the translation engine 111 indicates that it has used one of the other user dictionaries 113B to 113N to obtain a translated word, the extraneous translation highlighter 118 modifies the translation result so as to emphasize that translated word, by underlining, for example, or by use of color. The extraneous translation highlighter 118 also indicates the corresponding character string in the source document. If the translation engine 111 obtains two or more different translations of the same source character string from the other user dictionaries 113B to 113N, the extraneous translation highlighter 118 selects one of these translations for inclusion in the translation result, and attaches the other translations as alternative candidates. After this processing, the extraneous translation highlighter 118 sends the translation result to the display section 103.

The display section 103 comprises a result display unit 121 and a user dictionary editing unit 122, both of which differ slightly from the corresponding elements in the preceding embodiments.

When the result display unit 121 receives a translation result from the extraneous translation highlighter 118, it recognizes the parts indicated by the extraneous translation highlighter 118 as having been derived from other user dictionaries 113B to 113N, places these parts in a clickable state in the display of the translation result, supplies the corresponding source-document character strings, which were indicated by the extraneous translation highlighter 118, to the user dictionary editing unit 122, and activates the user dictionary editing unit 122.

The user dictionary editing unit 122 generates a dictionary-update display and sends user-dictionary editing information to the user dictionary processor 114 as in the preceding embodiments. In addition, if the user clicks on a word in the translation result that was translated by use of another user's dictionary, the user dictionary editing unit 122 displays a list of candidate translations obtained from all of the other user dictionaries 113B to 113N. If the user clicks on one of these candidate translations, the user dictionary editing unit 122 transfers it both to the translation column in the dictionary-update display and to the translation result, replacing the word that the extraneous translation highlighter 118 had selected for use in the translation result.

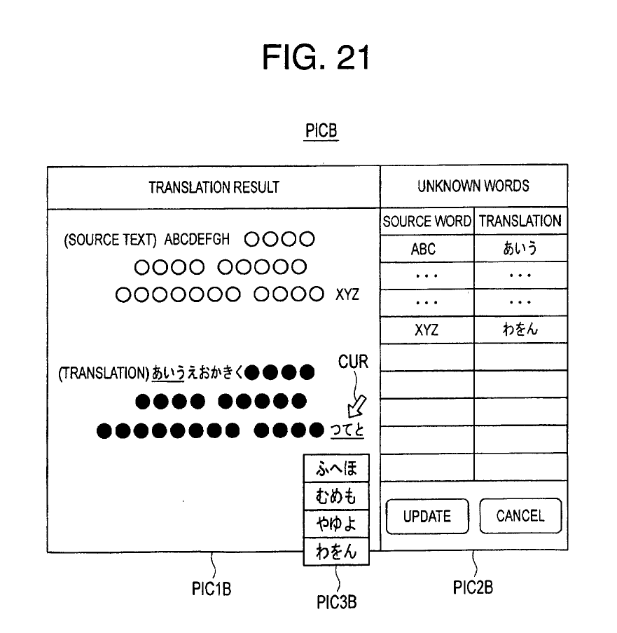

FIG. 21 shows an example of a display (PICB) produced by the display section 103 in FIG. 20. The display includes a first area (PIC1B) in which the translation result is displayed together with the source text, a second area (PIC2B) in which dictionary-editing information is displayed, and a third area (PIC3B) in which candidate translations are displayed. The first and last words of the translation are underlined to indicate that they were obtained from other users' dictionaries. Using the cursor (CUR), the user has clicked on the last word, causing the user dictionary editing unit 122 to display four other candidate translations of that word. Then the user has clicked on the last of these four candidate translations, causing the user dictionary editing unit 122 to enter it as the translation of XYZ in the dictionary-editing display PIC2B. The user dictionary editing unit 122 has not yet replaced the translation of XYZ in the translation result display (PIC1B), but is about to do so.

Initially, the dictionary-editing display (PIC2B) includes both the source words that were translated from other users' dictionaries and the translations of these source words that were selected by the extraneous translation highlighter 118.

The user dictionary editing unit 122 also generates a candidate translation display (PIC3B) if the user clicks on a source word or a translation in the dictionary-editing display (PIC2B).

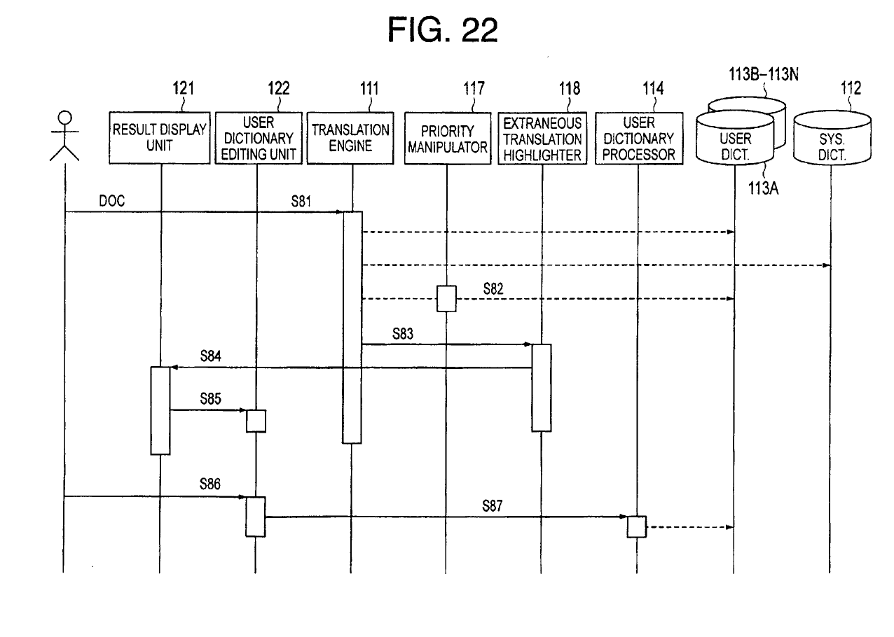

FIG. 22 illustrates the operation of the machine translation system 101B in FIG. 20.

When the user submits a document (DOC) to be translated, the translation engine 111 uses the system dictionary 112 and user dictionaries 113A to 113N to carry out the translation process (step S81). If the translation engine 111 cannot find a word in the system dictionary 112 and user dictionary 113A, the priority manipulator 117 directs the translation engine 111 to one of the other user dictionaries 113B to 113N (step S82), and the extraneous translation highlighter 118 adds information to the completed translation to indicate that the word in question has been translated using another user's dictionary (step S83). When the translation is completed, the extraneous translation highlighter 118 sends the translation result to the result display unit 121 (step S84).

The result display unit 121 displays the translation result in the first screen area PIC1A, placing words that were translated by use of other user dictionaries 113B to 113N in a clickable state, and marking these words by underlining, for example, or by displaying them in a different color. For these words, the extraneous translation highlighter 118 also provides the result display unit 121 with the corresponding source word, and with any other candidate translations that the translation engine 111 found in other user dictionaries 113B to 113N. The result display unit 121 passes this information to the user dictionary editing unit 122, which displays the source words and the translations selected by the extraneous translation highlighter 118 in the second screen area PIC2B, together with any unknown words that could not be found in either the system dictionary 112 or any of the user dictionaries 113A to 113N (step S85).

The user can now modify the dictionary-editing display (PIC2B) as described in the preceding embodiments, by using the keyboard to enter translations of unknown words, for example, or changing the translations of words that were translated with the use of other user dictionaries 113B to 113N (step S86). If the user clicks on one of these words in either the first screen area (PIC1B) or the second screen area (PIC2B), the user dictionary editing unit 122 displays a list of further candidate translations in the third screen area (PIC3B), and the user can select one of these further candidate translations by clicking on it.

When the user clicks on the ‘update’ button, the user dictionary editing unit 122 sends user-dictionary editing information to the user dictionary processor 114, which proceeds to update the user dictionary 113A (step S87).

Since the translation engine 111 can look up unknown words in all of the user dictionaries 113A to 113N, the probability that the translation result will be free of unknown words is higher than in the preceding embodiments.

To the extent that the extraneous translation highlighter 118 is able to select correct translations from the other user dictionaries 113B to 113N, the user has less work to do in editing his own user dictionary 113A than in the machine translation system 101A in FIG. 17.

The machine translation system 101B in FIG. 20 can be modified in various ways. The variations that were described in the preceding embodiments, for example, can be applied.

In another variation, when submitting the source document for translation, the user designates a set of other user dictionaries that may be used, and the translation engine 111, priority manipulator 117, and extraneous translation highlighter 118 use only the designated dictionaries, instead of using all of the other user dictionaries 113B to 113N.

In another variation, the dictionaries in the translation processing section 102 have a tree structure, and the user (or a system facility, such as the priority manipulator 117) can designate the dictionaries to be used to translate a particular document, but when a word cannot be found in any of the designated dictionaries, the priority manipulator 117 selects dictionaries located below the designated dictionaries in the tree structure.

When any of the preceding embodiments of the second aspect of the invention is used to translate a large quantity of source text, or to translate a source document that is divided into pages, the user dictionary editing unit 122 may divide the dictionary-editing display in a corresponding manner, so that, for example, only unknown words appearing in the first screen area are displayed in the second screen area. In this case, as the user proceeds from page to page in the translated document, the dictionary-editing display changes accordingly.

Alternatively, in the second screen area, unknown words, or words translated using other user dictionaries, may be displayed one by one instead of simultaneously. For example, the user dictionary editing unit 122 may start by displaying just one unknown word, wait for the user to finish entering or selecting a translation, and they display the next unknown word.

In a system in which different users maintain different user dictionaries, several users may pool their user dictionaries in a joint translation project.

The translation processing section 102 and display section 103 may operate in a server-client relationship. The translation processing section 102 may be linked through the Internet, for example, to a large number of display sections 103, thereby increasing the number of user dictionaries that can be edited by means of the present invention.

The system may recognize an unknown word not only when the word is not listed in the designated dictionaries, but also when the word is listed but has attributes, such as its part of speech, that contradict the usage of the word in the document being translated.

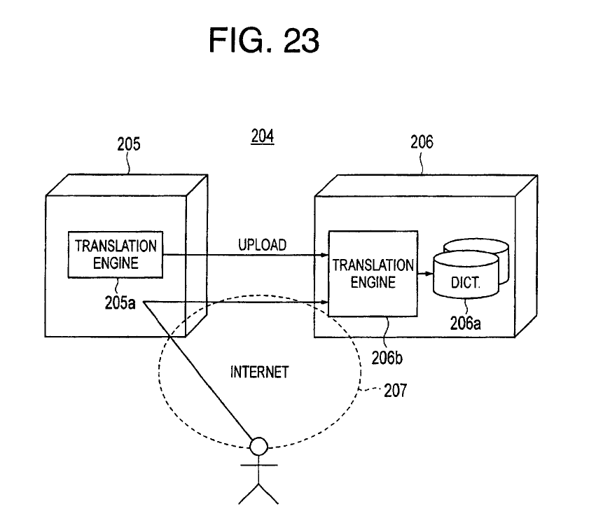

FIG. 23 schematically illustrates a distributed natural-language processing system embodying the third aspect of the invention, as applied to a dictionary-sharing machine translation system 204.

In this dictionary-sharing machine translation system 204, a plurality of translation servers 205, only one of which is shown, share a dictionary server 206 on a network 207 such as the Internet. The dictionary server 206 has at least one dictionary (DICT.) 206a, and normally has an extensive set of dictionaries, covering different languages and different specialized fields or genres. A translation engine 205a in the translation server 205 is uploaded into the dictionary server 206, and the uploaded translation engine 206b in the dictionary server 206 carries out the translation using the dictionaries 206a. The person who requested the translation then obtains the translation result through the translation server 205.

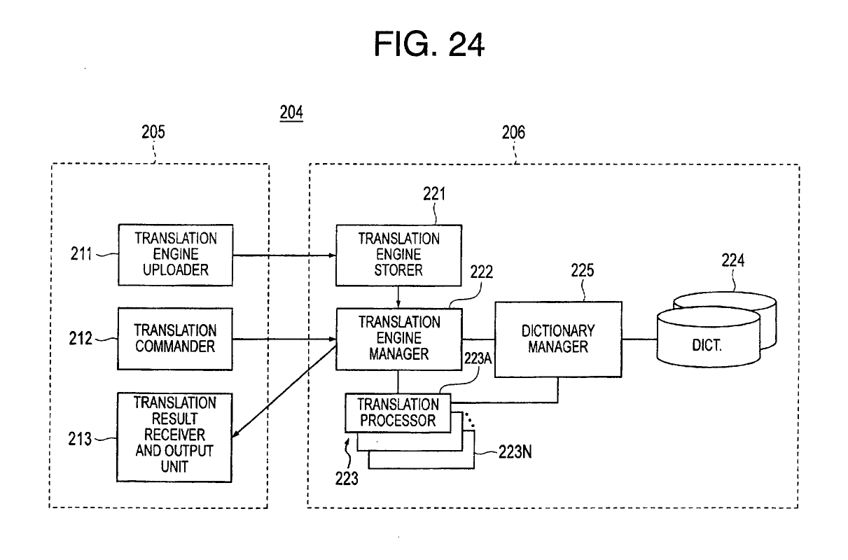

FIG. 24 shows the structure of this dictionary-sharing machine translation system 204 in more detail. The translation server 205 and the dictionary server 206 may each reside on a plurality of information-processing devices, but their functional block structure is as shown in this drawing.

The translation server 205 comprises a translation engine uploader 211, a translation commander 212, and a translation result receiver and output unit 213. The dictionary server 206 comprises a translation engine storer 221, a translation engine manager 222, a translation unit 223 with a plurality of translation processors 223A to 223N, a dictionary (DICT.) section 224, and a dictionary manager 225.

The translation engine uploader 211 uploads the translation engine 205a to the dictionary server 206. The translation engine 205a comprises a machine translation program and associated data; the program and data reside on a storage device (not visible), and may be considered to constitute part of the translation engine uploader 211. The translation engine has input and output functions such as an input function for documents to be translated and an output function for the translation results, but these need be only simple data transfer functions, since more extensive functions are provided by other components of the translation server 205 Uploading of the translation engine means that one or more files including copies of the machine translation program and associated data are transmitted from the translation server 205 to the dictionary server 206. After being uploaded, the translation engine also remains present in the translation server 205.

The translation engine uploader 211 may upload the translation engine when the translation of a document is requested, or it may upload the translation engine when the translation server 205 is activated in a translation mode, through an input unit not shown in the drawing. For example, the translation server 205 may also function as a document retrieval server for retrieving documents from the Internet, and may upload the translation engine to the dictionary server 206 when it receives a request for delivery of a document together with a translation of the document.

The translation commander 212 initiates the translation process by supplying the dictionary server 206 with the machine-readable data of the document to be translated, accompanied by a command to translate the document. If the dictionary section 224 includes different dictionaries for different categories, the command given by the translation commander 212 may also include instructions for selecting particular dictionaries. Needless to say, before giving a translation command, the translation commander 212 confirms that the translation engine uploader 211 has uploaded the translation engine. The translation commander 212 may be omitted if the translation engine uploader 211 transmits the data of the document to be translated together with the translation engine.

The translation result receiver and output unit 213 receives the translation result from the dictionary server 206 and outputs it to the person who requested the translation. Possible output methods include display on a screen, printing, and transmission to an information-processing terminal used by the person who requested the translation.

In the dictionary server 206, the translation engine storer 221, acting in cooperation with the translation engine manager 222, stores the translation engine received from the translation server 205 in one of the translation processors of the translation unit 223.

The translation unit 223 comprises N translation processors 223A to 223N, where N is a positive integer. The translation unit 223 includes a memory area for storing translation engines, and computational hardware for executing the machine translation programs in the stored translation engines. Preferably, the translation processor 223 includes a separate memory area and separate hardware (a separate CPU, for example) for each of the N translation processors 223A to 223N, so that the N translation processors 223A to 223N can run simultaneously and the dictionary server 206 can deal with translation requests from up to N translation servers 205 without strain on system resources. It is possible, however, to provide only separate memory areas for storing the translation engines, and use the same hardware to run all of them on a time-sharing basis. In this case a translation processor comprises a dedicated memory area and a share of other system resources such as CPU cycles.

If the N memory areas for storing translation engines in the translation unit 223 are all already occupied, the translation engine storer 221 informs the translation server 205 that its translation engine cannot be accommodated.

The translation engine manager 222 manages the translation unit 223 by allocating free memory space to the translation processors 223A to 223N, keeping track of the identity of the translation server 205 whose translation engine is stored in each of the N translation processors, and keeping track of which of these translation processors are currently executing machine translation programs.

The translation engine manager 222 also transfers documents between the translation servers and the translation processors in the translation unit 223. For example, if the translation engine uploaded from the translation server 205 shown in the drawing has been loaded into the memory of a particular translation processor 223X in the translation unit 223, then when the translation commander 212 in this translation server 205 submits a document to be translated, the translation engine manager 222 passes this document to translation processor 223X, receives the translation result from translation processor 223X, and transmits the translation result back to the translation server 205. After receiving the translation result, the translation engine manager 222 may also make the memory space of translation processor 223X available for storing another translation engine, either by deleting the currently stored translation engine, or by changing an entry in a directory managed by the translation engine manager 222 to indicate that translation engine stored in translation processor 223X may be replaced. Alternatively, after storing the translation engine of translation server 205 in the memory of translation processor 223X, the translation engine manager 222 may leave it there until a request to delete it is received from the translation server 205.

When storing the translation engine in the memory of translation processor 223X, the translation engine manager 222 also controls the dictionary manager 225 in such a way as to enable the dictionary section 224 to be accessed from translation processor 223X. If a translation request designating a particular set of dictionaries is received, the translation engine manager 222 controls the dictionary manager 225 so as to restrict access to those dictionaries.

The dictionary section 224 is thus shared by the translation engines in the translation processors 223A to 223N. In other words, the dictionary section 224 is shared by a plurality of translation servers 205.

The dictionary manager 225 controls access from the translation unit 223 to the dictionary section 224. Each translation processor in the translation unit 223, from translation processor 223A to translation processor 223N, accesses the dictionary section 224 through the dictionary manager 225, which controls the particular dictionaries the translation processor may use. The dictionary manager 225 thus knows which translation processor is accessing the dictionary section 224 at a particular time, and can furnish information read from the dictionary section 224 to the appropriate one of the translation processors. As one example of a control scheme that can be applied, the dictionary manager 225 may allocate time slots to the active translation processors. Alternatively, the dictionary manager 225 may use an arbitration algorithm to arbitrate between competing dictionary access requests. The dictionary manager 225 may also employ various conventional schemes that are used to give a plurality of translation servers direct access to the dictionaries in a shared dictionary server.

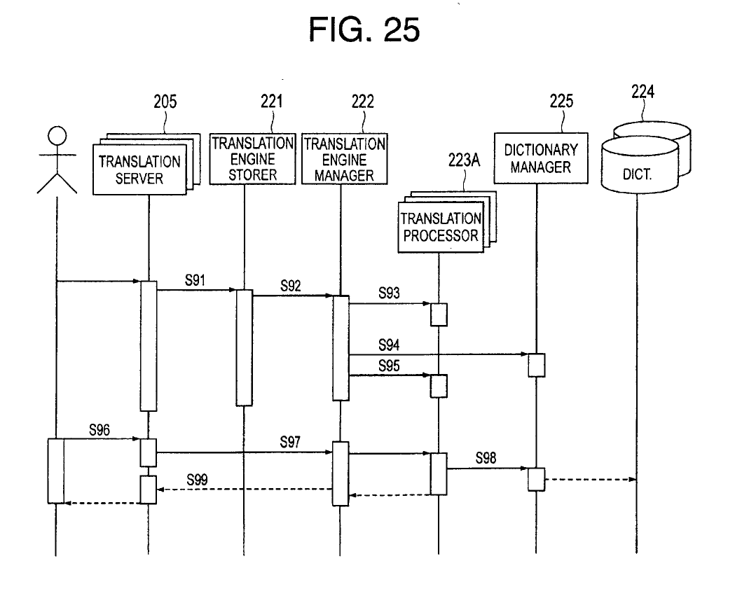

The operation of the dictionary-sharing machine translation system 204 in FIG. 23 is illustrated in FIG. 25.

First, a translation server 205 sends its translation engine to the translation engine storer 221 in the dictionary server 206 by, for example, uploading an executable file (step S91).

The translation engine storer 221 passes the translation engine to the translation engine manager 222, where it is temporarily buffered (step S92). If the translation unit 223 can accommodate this additional translation engine, the translation engine manager 222 loads the received translation engine into the memory area of one of the translation processors in the translation unit 223, translation processor 223A, for example, (step S93). The translation engine manager 222 also obtains a dictionary access interface from the dictionary manager 225 (step S94), and assigns it to the stored translation engine (step S95). More precisely, the translation engine manager assigns the access interface to the translation processor (e.g., translation processor 223A) into which the translation engine has been loaded. The dictionary access interface may be, for example, a time slot, a function call, or an entry pointer to a group of functions.

If a user now submits a document to be translated to the translation server 205 (step S96), the translation server 205 immediately sends the document and a translation request to the dictionary server 206, and the translation engine manager 222 in the dictionary server 206 passes the document to the translation processor (e.g., translation processor 223A) in which the translation engine of the translation server 205 is stored (step S97).

The translation processor 223A uses the dictionary access interface obtained in step S95 to scan the dictionary section 224, and executes the machine translation process (step S98). The translation result is returned through the translation engine manager 222 to the translation server 205, which supplies the result to the user (step S99).

When a plurality of translation processors in the translation unit 223 are active simultaneously, they all scan the dictionary section 224 simultaneously, but since most of the scanning involves only read access, simultaneous scanning of the dictionary section 224 causes no problems. When the dictionary section 224 is updated, the dictionary manager 225 locks out other access to the file being updated, or performs some other type of exclusive access control to ensure that access conflicts do not occur.

The effect of the dictionary-sharing machine translation system 204 is that network congestion is reduced because the dictionary section 224 is accessed only from within the dictionary server 206. Particularly when a single translation server 205 receives a large number of translation requests, or when a long document must be translated, it is more efficient to transfer the translation engine and the documents to be translated to the dictionary server 206, and transfer the translation results back to the translation server 205, than to maintain a constant dictionary access traffic between the translation server 205 and the dictionary server 206.

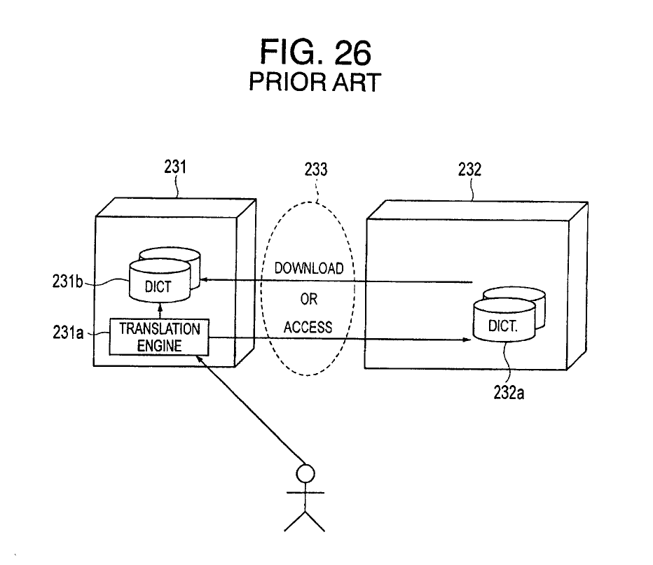

For comparison, FIG. 26 shows a conventional distributed machine translation system in which a translation server 231 and a dictionary server 232 are linked by a network 233 such as the Internet. The translation server 231 includes a translation engine 231a and a dictionary unit 231b. The dictionary server 232 includes a dictionary unit 232a in which various dictionaries are stored. The translation engine 231a executes in the translation server 231, so when a translation is performed, the necessary dictionaries must be downloaded from the dictionary unit 232a in the translation server 232 to the dictionary unit 231b in the translation server 231. Dictionaries are in general larger than the documents they are used to translate, so this transfer consumes more bandwidth in the network 233 than transfer of the document would consume. Alternatively, the translation engine 231a may repeatedly access the dictionary unit 232a in the dictionary server 232, looking up only the words it needs, but this type of repeated access also consumes considerable network bandwidth.

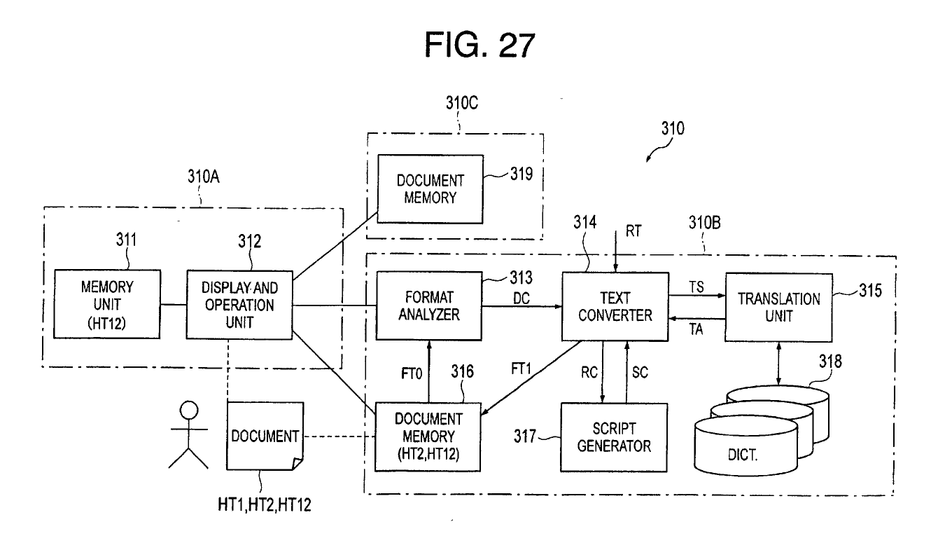

FIG. 27 shows the structure of a machine translation and document display system 310 embodying the fourth aspect of the invention. This system translates HTML documents (Web pages) obtained from the World Wide Web. The documents thus include embedded information (HTML tags) specifying layout, text size, fonts, and so on, and providing links to other documents.

The machine translation and document display system 310 in FIG. 27 includes a user terminal 310A that is linked by the Internet to a pair of server machines 310B, 310C. The user terminal 310A includes a memory unit 311 and a display and operation unit 312. The user terminal 310A may be, for example, a personal computer.

The memory unit 311 is a storage means comprising semiconductor memory, a hard disk, and the like, built into the user terminal 310A. The display and operation unit 312 includes hardware such as a bit-mapped display device and keyboard, and software such as a Web browser. These facilities enable the user terminal 310A to display a hypertext document HT1, have server machine 310B translate document HT1 into another language, display the translated document HT2, and store the displayed documents HT1, HT2, and perform other functions.

Server machine 310B includes a format analyzer 313, a text converter 314, a translation unit 315, a document memory 316, a script generator 317, and a dictionary (DICT.) unit 318. Server machine 310C includes at least a document memory 319 and facilities enabling the documents stored therein to be viewed from browsers running on user terminals such as user terminal 310A.

When the user terminal 310A requests the translation of a hypertext document HT1, the format analyzer 313 stores a copy FTO of document HT1 in the document memory 316, then analyzes the tags embedded in this hypertext document by, for example, analyzing the identifying names of the tags and the names of event handlers, script functions, and the like that follow the tag names. In this way, the format analyzer 313 separates the text to be translated from the tag information, and converts the document to an analyzed document DC that can be processed by the text converter 314. The analyzed document DC includes both the source character strings (including tags) occurring in the document HT1, and information obtained from the analysis of these strings performed by the format analyzer 313.

The text converter 314 is linked to the translation unit 315 and script generator 317. The text converter 314 uses these facilities to convert the analyzed document DC to a mixed hypertext document HT12 characteristic of the present embodiment. More specifically, the text converter 314 converts the source character strings (including tags) of the analyzed document DC to a mixture of translated text, tags, event handlers, script, and source text. When this mixed hypertext document HT12 is displayed, at first only the translated text is displayed, but the user can perform certain operations (described later) to have the source text corresponding to specified translated text displayed. This function is implemented through script language embedded in the tags of the mixed hypertext document.

A script language is a type of programming language that is interpreted and executed by software and hardware in the user terminal 310A. The script language used in the present embodiment is JavaScript, an object-based programming language designed to be embedded in HTML files and interpreted and executed from within a browser. Although the capabilities of JavaScript as an independent programming language are limited, it is effective for interactive browsing when used together with HTML.

Both JavaScript and the HTML tags are interpreted and executed by an interpreter provided in the browser in the display and operation unit 312. Although HTML itself can be classified as a type of script language, the word ‘script’ will be used below to refer to JavaScript; HTML will be considered as a type of markup language.

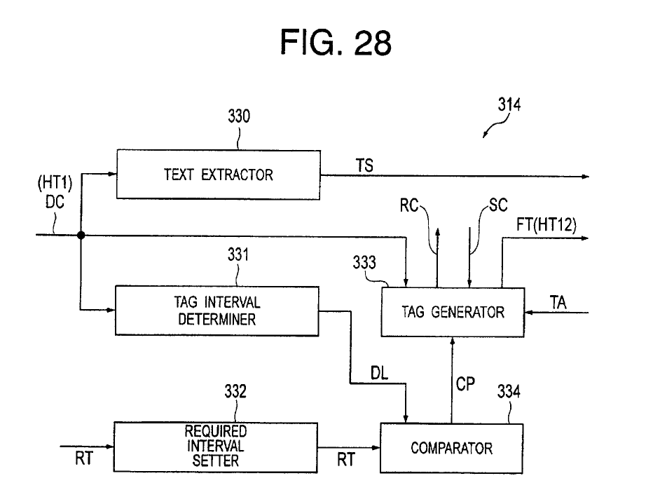

FIG. 28 shows the internal structure of the text converter 314. The component elements of the text converter 314 are a text extractor 330, a tag interval determiner 331, a required interval setter 332, a tag generator 333, and a comparator 334.

The text extractor 330 receives the analyzed document DC, extracts the text strings TS to be translated, and supplies them to the translation unit 315.

The tag interval determiner 331 also receives the analyzed document DC. By checking the separation of tags, the tag interval determiner 331 determines how much translated text (for example, one word, one sentence, or one paragraph) should occur between each pair of tags, and outputs tag interval data DL giving this information.

HTML normally uses a so-called p-tag (designating an indented new line) to indicate each new paragraph, so even in the absence of font specifications and the like, the maximum interval between tags normally does not exceed one paragraph. Since tags are inserted at the discretion of the person who creates the source document HT1, however, there may be considerable variation in the distance between tags, ranging from one character to one paragraph, and there may also be considerable variation in the length of paragraphs. A paragraph may continue for more than one page, for example.

For that reason, if JavaScript is embedded using only the tags present in the source document HT1, in some cases, navigation within the mixed hypertext document HT12 will become difficult. The required interval setter 332, tag generator 333, and comparator 334 deal with these cases by embedding additional tags at fixed intervals to make the mixed hypertext document HT12 easier to use.

The required interval setter 332 receives requested tag interval data RT from an external source, such as a file in which system parameters are stored. An interval of one sentence, for example, is suitable as the requested tag interval RT.

The comparator 334 receives the requested tag interval RT from the required interval setter 332, compares it with the tag interval data DL output by the tag interval determiner 331, and activates a comparison result signal CP when a tag interval in the tag interval data DL exceeds the requested tag interval RT.

This signal CP is received by the tag generator 333, which also receives the analyzed document DC, the translation result TA, and script information (mainly JavaScript) SC. On the basis of this information, the tag generator 333 generates an HTML file FT1 corresponding to the mixed hypertext document HT12. The tag generator 333 may also output a script generation request RC asking the script generator 317 to generate script information SC.

In generating the HTML file FT1, when the comparison result signal CP is active, the tag generator 333 generates tags that were not present in the source hypertext document HT1, and embeds them at the requested tag interval RT. These tags are used only to embed script information SC, so in principle any type of HTML tag can be used, but to avoid affecting the layout and fonts of the document, it is advisable to use, for example, a font tag specifying the font of the character immediately preceding the tag.

When the comparison result signal CP is inactive, the source hypertext document HT1 already includes tags at intervals equal to or less than the requested tag interval ART, so the tag generator 333 does not generate new tags, but uses the existing tags to embed script information SC.

When the script generator 317 in FIG. 27 receives a script generation request RC from the tag generator 333, it automatically generates script information SC (JavaScript) and supplies this information to the tag generator 333. Script languages are intelligible even to human beings; so it is comparatively easy to generate script automatically The JavaScript generated by the script generator 317 in response to a request RC may be nearly identical in content to the request, or have closely corresponding content.

The translation unit 315 receives text TS to be translated from the text extractor 330, executes the machine translation process by using the dictionary unit 318, and supplies the resulting translated text TA to the tag generator 333.

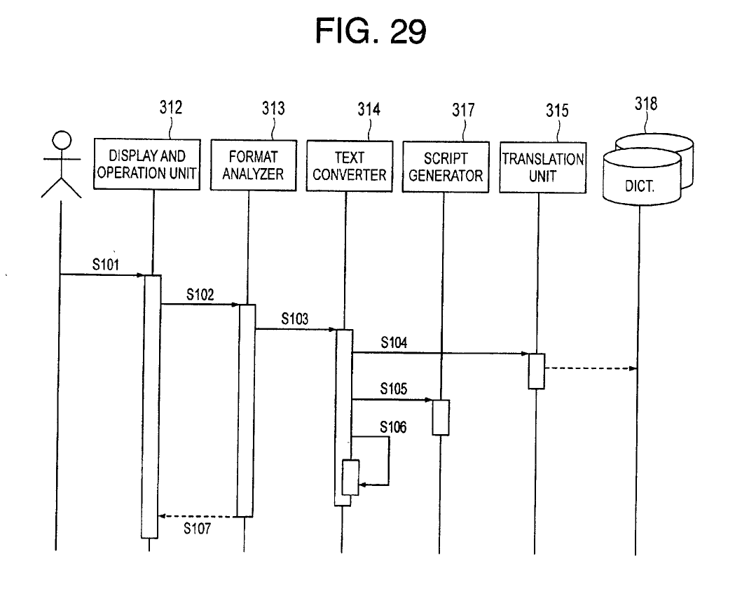

The operation of the machine translation and document display system 310 is illustrated in FIG. 29.

In FIG. 29, the user has used the display and operation unit 312 to obtain a source hypertext document HT1 from the document memory 319 in server machine 310C, and has requested machine translation of document HT1. Document HT1 is then transferred from the display and operation unit 312 through a network to server machine 310B (step S101). The transfer can be carried out by use of HTML mail, for example. Alternatively, server machine 310B may obtain document HT1 directly from server machine 310C. If document HT1 is already stored in the document memory 316 in server machine 310B, this step S101 may be omitted.

In server machine 310B, the format analyzer 313 analyzes the source hypertext document HT1 (step S102) and supplies an analyzed document DC to the text converter 314 (step S103).

In the text converter 314, the text extractor 330 extracts the text to be translated and supplies the extracted text TS to the translation unit 315 (step S104). The translation unit 315 uses the dictionary unit 318 to execute the machine translation process, generating a translation result TA. During the machine translation process, the text converter 314 begins preparing for the replacement process (step S106) that it will execute later.

As one of the preparations, the tag generator 333 in the text converter 314 may send the script generator 317 a script generation request RC (step S105). The script generator 317 generates the requested script and supplies it to the tag generator 333.

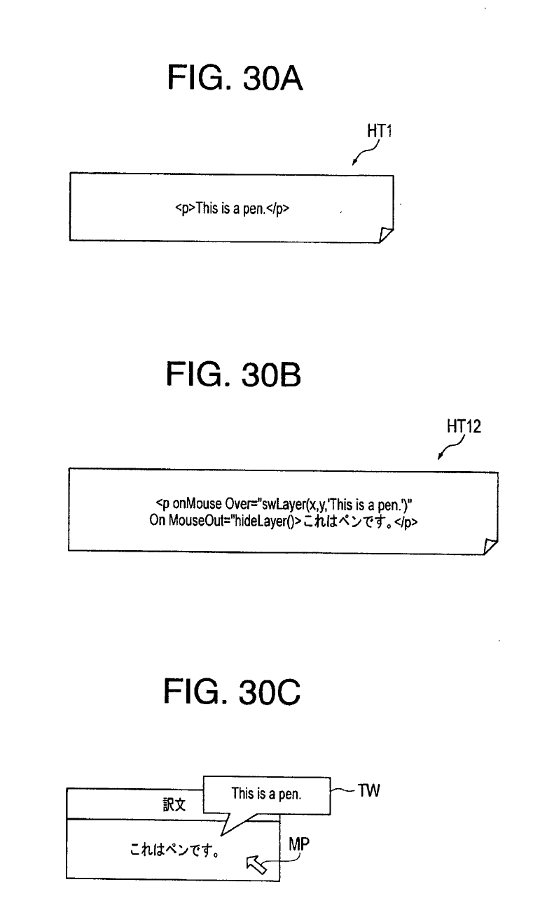

Examples of script generated by the script generator 317 are shown in FIG. 30B. One example is the character string “swLayer(x,y,‘This is a pen.’)” in the first line of FIG. 30B. Another example is the character string “hidelayer( )” in the second line. Incidentally, “onMouseOver” and “onMouseOut” indicate event handlers that process input from a pointing device manipulated by the user. These event handlers are also included in the script information SC generated by the script generator 317.

The following two lines are an example of JavaScript:

onMouseOver=“swLayer(x,y,‘This is a pen.’)”

onMouseOut=“hideLayer( )”

The meaning of this script is that when the mouse cursor is positioned on the following Japanese sentence (‘kore wa pen desu,’ shown in Japanese characters in the second line in FIG. 30B), the English sentence (‘This is a pen’) of which the Japanese sentence is a translation is to be displayed, and when the mouse cursor is moved away from this Japanese character string, the display of the English sentence (‘This is a pen’) is to be terminated.

After the requested script has been generated and the machine translation process has been completed, the text converter 314 replaces the analyzed document DC with information assembled from the analyzed document DC, the translation result TA, and the requested script information SC, inserting new tags as necessary (step S106).

FIG. 30A shows an example of a short paragraph (delimited by tags <p> and </p>) in the source hypertext document HT1, consisting of the single English sentence ‘This is a pen.’ If the comparison result signal CP is inactive for the duration of this sentence, then the tag generator 333 does not have to insert new tags, but it replaces the <p> tag with the longer tag shown in FIG. 30B, which includes the English sentence and script generated by the script generator 317, and replaces the English sentence itself with its Japanese translation, which is obtained from the translation result TA.

If, for example, the requested tag interval RT is one sentence; then the replacement process is carried out repeatedly, one sentence at a time, to create the mixed hypertext document HT12. This document HT12 is stored in the document memory 316, and is transferred by the format analyzer 313 from the document memory 316 to the display and operation unit 312 in the user terminal 310A (step S107).

As noted above, when the user uses the display and operation unit 312 to view the mixed hypertext document HT12, normally only the translated text is visible. If the user clicks on a particular translated sentence by moving the mouse pointer MP to that sentence and pressing a button or key, however, then a text window TW pops up and the source sentence (e.g., ‘This is a pen’) is displayed in that window, as illustrated in FIG. 30C. If the mouse pointer is then moved away from the sentence, the text window TW disappears.

The mixed hypertext document HT12 is a single HTML file, although it combines both the source hypertext document HT1 and the translated hypertext document HT2. Moreover, the layout of the source hypertext document HT1 is completely preserved when the translated text is displayed.

At a later time, even if the source hypertext document HT1 is modified or deleted from the document memory 319 in server machine 310C, a user of the user terminal 310A can still obtain the mixed hypertext document HT12 from the document memory 316 in server machine 310B, display the translated text, and view the unmodified source text.

Furthermore, since the source text is displayed only when necessary, and can be displayed in small units, such as one sentence at a time, the user will find it easier to use the mixed hypertext document HT12 than to compare the translated text with the source document HT1 stored in server machine 310C, even if the source document HT1 has not been modified or deleted.

It is also an advantage that only a single mixed hypertext document HT12 has to be stored and managed. A conventional system that produces and stores a translated hypertext document H2 and stores both the translated document HT2 and the source document HT1, so that the user can view and compare both documents even if the source document is deleted from its original location in the document memory 319, must store two separate HTML files Hi and H2. Then if the source document is modified, the system must store two different copies HT1, HT1′ of the source document, and two different translations HT2, HT3.

In regard to file size, since the mixed hypertext document HT12 includes both the source text and the translated text, as well as event handlers and other script, the mixed hypertext document HT12 is apt to be about two to three times as large as the source hypertext document HT1. Since many source hypertext documents are comparatively small, however, with file sizes on the order of a few kilobytes, and since file storage systems in general include cluster gaps, in many cases the increased size of the mixed hypertext document HT12 is not a significant disadvantage.

More specifically, in many file storage systems, the minimum storage unit is a cluster with a size of thirty-two kilobytes or sixty-four kilobytes, so even the smallest possible HTML file, with a size of only one byte, for example, consumes at least thirty-two kilobytes of storage space. In many cases, accordingly, the mixed hypertext document HT12 can be stored in a single cluster, consuming no more storage space than the source hypertext document itself. For example, it is twice as efficient to store a single mixed hypertext document HT12 with a size of thirty kilobytes in this type of file system than to store a ten-byte source hypertext document and a ten-byte translated document as separate files.

Incidentally, it is not necessary to leave the mixed hypertext document HT12 stored indefinitely in the document memory 316. The mixed hypertext document HT12 can be stored in the document memory 319 or memory unit 311 instead.

Compared with the conventional practice of embedding links to the source hypertext document HT1 in a translated hypertext document HT2, the machine translation and document display system 310 in FIG. 27 also has the advantage of reducing traffic between the user terminal 310A and server machine 310C, thereby reducing network congestion. The user is assured of being able to view source text swiftly and easily, without having to wait for the source text to be transferred from a distant server.

Other benefits to the user include being able to view the translated text in the same format as the source text, and being able to display pieces of source text in a convenient way.

From the point of view of server machine 310B, storing a single mixed hypertext document HT12 instead of storing the source hypertext document HT1 and a translated hypertext document HT2 reduces file management costs, including both the cost of storage space, as explained above, and the cost of maintaining file directory information and performing other file maintenance operations.

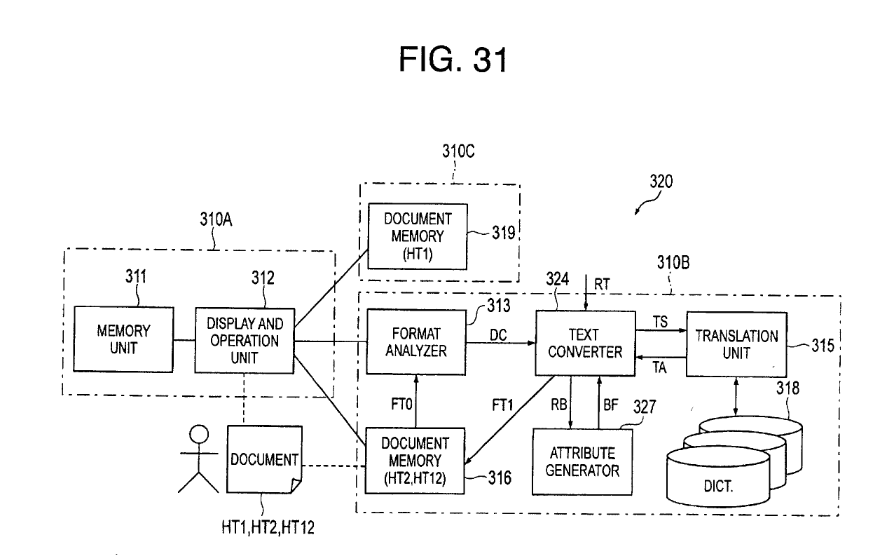

FIG. 31 shows another machine translation and document display system embodying the fourth aspect of the invention, this system employing the extensible markup language (XML) instead of HTML.

XML is a markup language advocated by the World Wide Web Consortium (W³C). Compared with HTML, XML has enhanced tag functions, does not allow tags to be omitted, and facilitates tag processing through a simple syntax. For the present embodiment, an important feature of XML is that style and content can be described separately, style being described in an extensible stylesheet language (XSL). This feature makes it possible to store both a source text (in English, for example) and a translated text (in Japanese, for example) as content, together with an XSL style file, and selectively display either the source text or translated text in the designated style.

The description of the machine translation and document display system 320 in FIG. 31 will be confined to the differences from the machine translation and document display system 310 in FIG. 27. One difference is the replacement of the script generator 317 in FIG. 27 with an attribute generator 327 in FIG. 31. Further differences concern the operation of the text converter 324. Component elements 311, 312, 313, 315, 316, 318, and 319 are similar to the corresponding elements in FIG. 27.

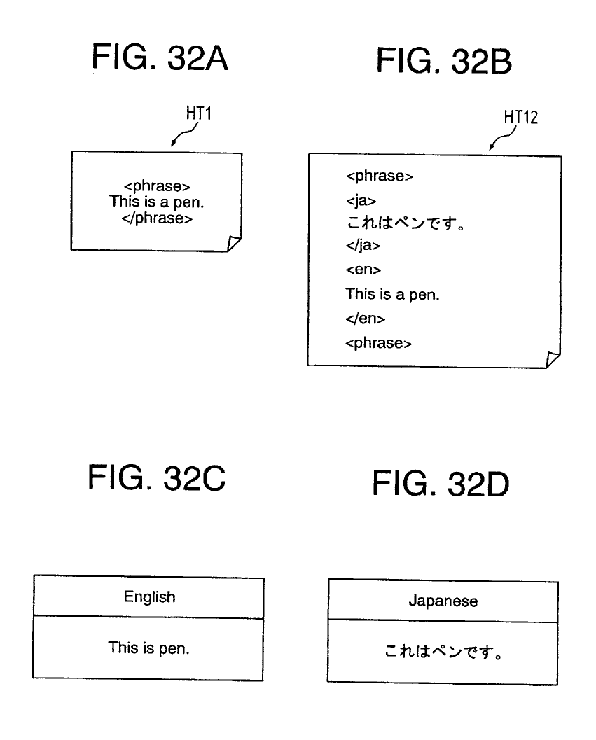

The attribute generator 327 responds to an attribute generation request RB from the browser and input device 24 by generating a form BF with attributes of the source text and translated text. These attributes include language attributes such as Japanese, indicated by the tags <ja> and </ja> in FIG. 32B, and English, indicated by the tags <en> and </en>.

The text converter 324 generates the mixed hypertext document H12 by, for example, replacing the XML phrase shown in FIG. 32A with the longer XML phrase shown in FIG. 32B.

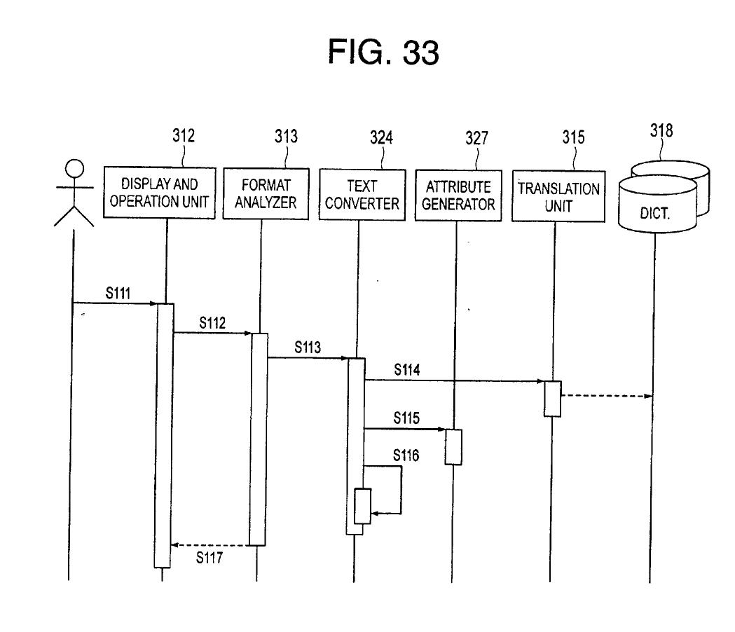

The operation of the machine translation and document display system 320 is illustrated in FIG. 33. Steps S111, S112, S113, S114, and S117 are substantially the same as the corresponding steps S101, S102, S103, S104, and S107 in FIG. 29.

Accordingly, when the user requests a translation of a source document HT1, the source document HT1 is input to the display and operation unit 312 (step S111) and analyzed (step S112). The analyzed document DC is supplied to the text converter 324 (step S113), which extracts the text to be translated and sends this text to the translation unit 315 (step S114).

As the text is being translated by use of the dictionary unit 318, the text converter 324 sends a request to the attribute generator 327 to generate format specifications giving attributes of the source text and translated text (step S115). The attribute generator 327 generates specifications such as, for example, the ones shown in FIG. 32B. The text converter 324 then generates the mixed hypertext document H12 by replacing source text with a mixture of source text, translated text, and these attributes (step S116). The mixed hypertext document H12 is transferred to the display and operation unit 312 (step S117) and displayed by the browser at the display and operation unit 312.

During the display, the user can specify a language through a style file such as an XSL file to see either the source text as in FIG. 32C, or the translated Japanese text as in FIG. 32D. The display and operation unit 312 displays both versions of the text in the same way; only the user is aware that one is the source text and the other is the translation. The user can switch between the two versions with a single action that swaps style files, so the system is easy for the user to operate.

If the source hypertext document HT1 is an HTML document or has some other format different from XML, the format can be converted to XML by well-known converters before the above processing is carried out.

This second embodiment of the fourth aspect of the invention has much the same effect as the preceding embodiment, but by using XML and XSL technology, it can provide some further variations not supported by HTML.

Incidentally, it is not necessary for all of the component elements 313 to 318 shown in FIG. 27, or 313, 315, 316, 318, 324, and 327 shown in FIG. 31, to reside within server machine 310B. Some or all of these component elements may reside on another server machine (not visible).

The user terminal 310A need not be connected directly to server machine 310B and server machine 310C as shown in FIGS. 27 and 31; there may be other servers and networks disposed in between.

The fourth aspect of the invention is not limited to the specific script languages and markup languages mentioned above; other languages can be used. Furthermore, even if HTML, for example, is used, the invention is not restricted to the current version of this rapidly-evolving standard. FIGS. 30A, 30B, and 30C, for example, illustrate only the current HTML version and corresponding browser capabilities.

In FIG. 30C, a text window TW was made to pop up in response to an operation with a mouse pointer MP, but the source text can be displayed in a fixed window when a translated character string is entered from the keyboard, for example.

It is not necessary for the text converter 314 in FIG. 27 to ensure that tags occur at predetermined intervals RT by inserting new tags. The tag interval determiner 331, required interval setter 332, and comparator 334 in FIG. 28 can be omitted, and the text converter 314 can simply add script (including event handlers) to existing tags, regardless of the intervals between these tags.

The fourth aspect of the invention has been described in relation to the Internet, but is not restricted to use on the Internet. The same technique can be applied in other networks and systems, such as intranet systems, that provide hypertext documents to users.

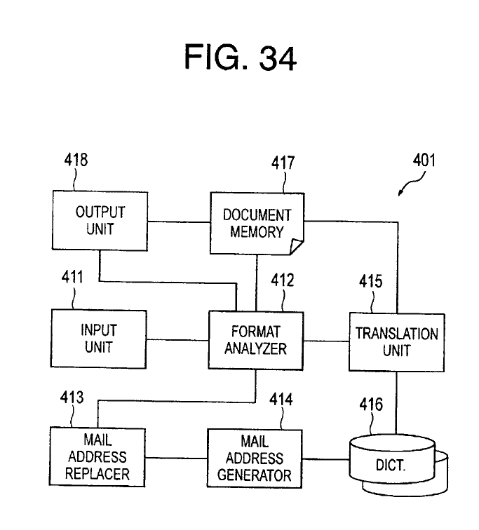

FIG. 34 shows the structure of a machine translation system embodying the fifth aspect of the invention. This machine translation system 401 can be constructed on one or more information-processing facilities such as servers on the Internet, but regardless of the hardware configuration, the functional configuration is basically as shown in FIG. 34.

The machine translation system 401 in FIG. 34 comprises an input unit 411, a format analyzer 412, a mail address replacer 413, a mail address generator 414, a translation unit 415, a dictionary unit 416, a document memory 417, and an output unit 418.

The input unit 411 has facilities for entering or specifying a document to be translated. For example, the input unit 411 may have a keyboard or disk drive from which the document may be specified or read, or a communication link to a distant device from which the document is transmitted. In particular, if the machine translation system 401 is constructed on the Internet, the input unit 411 may have a communication link to a document retrieval server that provides Web pages on request.

The format analyzer 412 analyzes the format of the input document, extracts the text to be translated, provides this text, which may include electronic mail addresses, to the translation unit 415, and sends the other parts of the input document to the document memory 417. If the input document includes electronic mail addresses, the format analyzer 412 also extracts these electronic mail addresses and supplies them to the mail address replacer 413. Electronic mail addresses may be extracted by format analysis or by other methods.

If the input document is a Web page including HTML tags, for example, the format analyzer 412 places the tags in the document memory 417 so that they can later be added to the translation result, and sends the rest of the document, with the tags removed, to the translation unit 415. If the document includes tags identifying electronic mail addresses, the mail address replacer 413 may use these tags to extract the electronic mail addresses, but the format analyzer 412 may also extract electronic mail addresses by detecting the at-sign (@), thereby recognizing an electronic mail address as an alphanumeric character string including one at-sign and no spaces.

The format analyzer 412 may also use the content of the electronic mail addresses to decide whether or not machine translation is necessary.

The mail address replacer 413 receives the electronic mail addresses supplied by the format analyzer 412, and initiates the process of generating new electronic mail addresses. The significance of this will be explained later.

The new electronic mail addresses are generated by the mail address generator 414. Information for generating electronic mail addresses may be stored in part of the dictionary unit 416. Furthermore, the newly generated electronic mail addresses may be stored in a dictionary in the dictionary unit 416 as translations of the electronic mail addresses from which they are generated, thereby causing them to be included in the translation result. Alternatively, the newly generated electronic mail addresses may be returned through the mail address replacer 413 to the format analyzer 412, and the format analyzer 412 may insert the new electronic mail addresses in the translation result.

The translation unit 415 executes a machine translation process that converts the text of the input document from its original language to the target language. Any of various known machine translation methods may be employed. During the translation process, the translation unit 415 makes use of the dictionary unit 416, which may include both system dictionaries and user dictionaries.

The document memory 417 stores the translation result (translated text) obtained from the translation unit 415, attaching the format information (tags) supplied from the format analyzer 412 at appropriate points. When the entire translation process has been completed, the document memory 417 stores a complete translation of the input document.

The output unit 418 outputs this complete translation result to, for example, a display unit, a printer, or a communication device that transmits the translation result to another location. If the translation result is transmitted, the electronic mail address to which the translation result is sent may be obtained directly by the format analyzer 412, or the format analyzer 412 may obtain an appropriate electronic mail address from the mail address replacer 413.

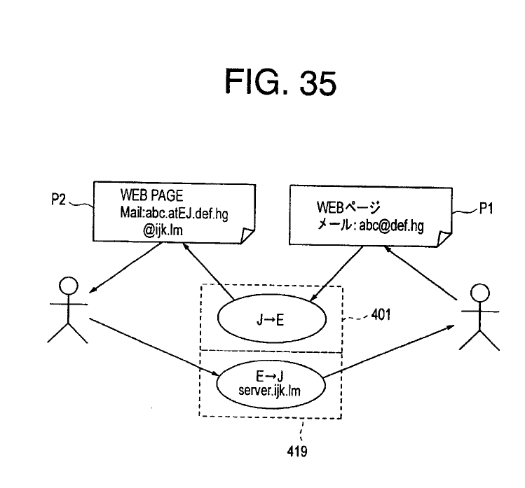

FIG. 35 shows an example explaining the effect of the conversion of electronic mail addresses. In this drawing, a Web page author has created a Web page P1 in a first language (Japanese), including his or her own electronic mail address abc@def.hg as a contact address. This Web page PI is then translated by the machine translation system 401 into a second language (English), and the translated Web page P2 is viewed by a person who is more familiar with the second language than the first language. In the translated Web page P2, the contact address has been converted to abc.atEJ.def.hg@ijk.lm. This new electronic mail address routes mail to an electronic-mail machine translation system 419, which may simply be a functional extension of the machine translation system 401 or may be a separate machine translation system. The two languages are designated by the ‘.atEJ.’ part of the new electronic mail address, indicating that arriving mail is to be translated from English into Japanese. The electronic-mail machine translation system 419 translates the electronic mail, and sends the translated mail to the original address (abc@def.hg).

To avoid the generation of an unwanted at-sign, if the character string ‘.at’ occurs in the original electronic mail address of the page author, this is converted to ‘.atat’ by the machine translation system 401, and is then converted back to ‘.at’ by the electronic-mail machine translation system 419.

Accordingly, if a person who has viewed Web page P2 sends electronic mail in the second language (English) to the author of the page, this mail will be translated into the first language (Japanese) by the electronic-mail machine translation system 419, and the translated mail will be forwarded to the page author at address abc@def.hg.

The Web page author thus receives electronic mail in his or her own language, even from people who view the translated Web page P2.

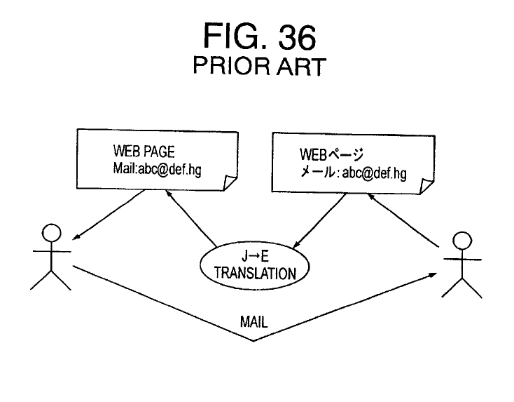

For comparison, FIG. 36 shows a similar example in which a Web page is translated without replacement of the page author's electronic mail address. In this case the page author receives electronic mail in the second language, which the page author may not be able to read easily.

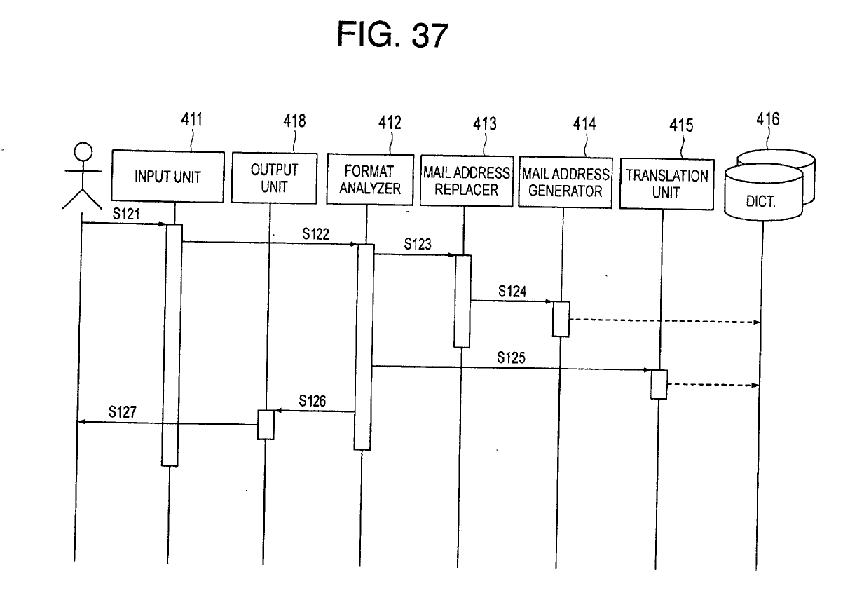

The operation of the machine translation system 401 is further illustrated in FIG. 37. A person using a Web browser or the like at the input unit 411 enters or specifies a document to be translated from the first language to the second language (step S121). The document may have been obtained from a document retrieval system, for example, or translation of the document may be specified when retrieval is requested.

In the machine translation system 401, the format of the input document is analyzed by the format analyzer 412 (step S122). If an electronic mail address is present in the analyzed document, the electronic mail address is supplied to the mail address replacer 413 (step S123). The mail address replacer 413 invokes the mail address generator 414 (step S124), which generates a new electronic mail address that routes electronic mail through the electronic-mail machine translation system 419. The new electronic mail address is generated by use of the dictionary unit 416, for example, with reference to the language of the input document and the language into which it is being translated, and includes information designating these two languages.

The textual part of the input document is also submitted to the translation unit 415 (step S125) and translated from the first language to the second language by use of the dictionary unit 416. Steps S124 and S125 may be carried out in parallel, as shown, in which case the electronic mail address in the translation result is replaced by the new electronic mail address generated by the mail address generator 414. Alternatively, step S124 may be carried out first, and the document may be submitted for translation after the electronic mail address therein has been replaced by the new electronic mail address generated by the mail address generator 414.

In either case, the final translation result includes the new electronic mail address. This translation result is supplied to the output unit 418 (step S126), and viewed by the person who requested the translation (step S127).

As explained above, when a Web page is translated by the machine translation system 401, the electronic mail addresses in it are converted to electronic mail addresses that better serve the interests of the provider of the Web page. In FIG. 35, for example, an electronic mail address is converted so as to route mail through an electronic-mail machine translation system 419 that translates mail from the second language to the first language, ensuring that the Web page provider receives mail in his or her own language.

The machine translation system 401 has been described above as translating a document at the request of a person who wants to view the document, but the machine translation system 401 can also be used to translate a document at the request of the person who creates the document.

In generating a new electronic mail address, the mail address generator 414 may route mail through different machine translation systems, depending on the language of the input document and the language into which the document is translated.

The machine translation system 401 may be configured as a stand-alone machine translation system, instead of being configured on a server on the Internet.

The process of replacing electronic mail addresses may be invoked after the machine translation process has been completed.

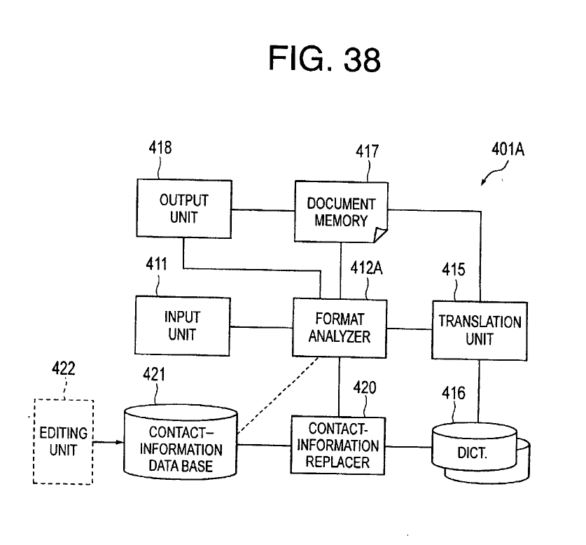

FIG. 38 shows the functional block structure of another machine translation system 401A embodying the fifth aspect of the invention. This machine translation system 401A may also be configured on one or more servers or other information-processing equipment in a network.

The machine translation system 401A comprises an input unit 411, a format analyzer 412A, a translation unit 415, a dictionary unit 416, a document memory 417, an output unit 418, a contact-information replacer 420, and a contact-information data base 421. The input unit 411, translation unit 415, dictionary unit 416, document memory 417, and output unit 418 are similar to the corresponding elements in the machine translation system 401 in FIG. 34.

The format analyzer 412A analyzes the format of an input document, passes the textual part (which may include electronic mail addresses) to the translation unit 415, places the non-textual part in the document memory 417, and supplies any contact information appearing in the input document to the contact-information replacer 420. The term “contact information” as used herein refers to any type of information that a reader of the input document can use to get in touch with the author or provider of the document, such as an electronic mail address, a clickable mail tag, a postal address, a telephone number, the name of a person, company, or office, or some combination of these items. Contact information may also be included in a coded form, as described later. Contact information may be extracted by format analysis or by other methods.

If the input document is a Web page including HTML tags, for example, the format analyzer 412A places the tags in the document memory 417 so that they can later be added to the translation result, and sends the rest of the document, with the tags removed, to the translation unit 415. If the document includes tags identifying contact information, the format analyzer 412A may use these tags to extract the contact information, but the format analyzer 412A may also extract contact information by detecting character strings that match character strings in the contact-information data base 421.

By referring to the contact-information data base 421, the contact-information replacer 420 replaces the contact information received from the format analyzer 412A with new contact information suitable for the language into which the input document is translated by the translation unit 415. The contact-information replacer 420 may also refer to the dictionary unit 416 as necessary. The contact-information replacer 420 may place the new contact information in the dictionary unit 416, so that it will be automatically included in the translation result as a translation of the contact information in the input document. Alternatively, the contact-information replacer 420 may furnish the new contact information to the format analyzer 412A, and the format analyzer 412A may insert the new contact information in the translation result.

The contact-information data base 421 stores contact information suitable for the first language and corresponding contact information suitable for the second language. Alternatively, the contact-information data base 421 stores codes and corresponding contact information, so that a code included in the input document can be converted to contact information suitable for inclusion in the translation result. If the document is intended for translation into more than one target language, separate contact information may be provided for each target language. Contact information in the source language may also be provided, so that the machine translation system 401A can be used to insert contact information into documents even when the documents are not translated.

The contact information is stored in the contact-information data base 421 by use of an editing unit 422. Details of the storage process will be omitted, since the process is similar to the process of updating a system dictionary or user dictionary in a machine translation system. The contact information may be stored by a system operator at the request of people who create documents that will be submitted to the machine translation system 401A for translation, or may be stored directly by these people themselves.

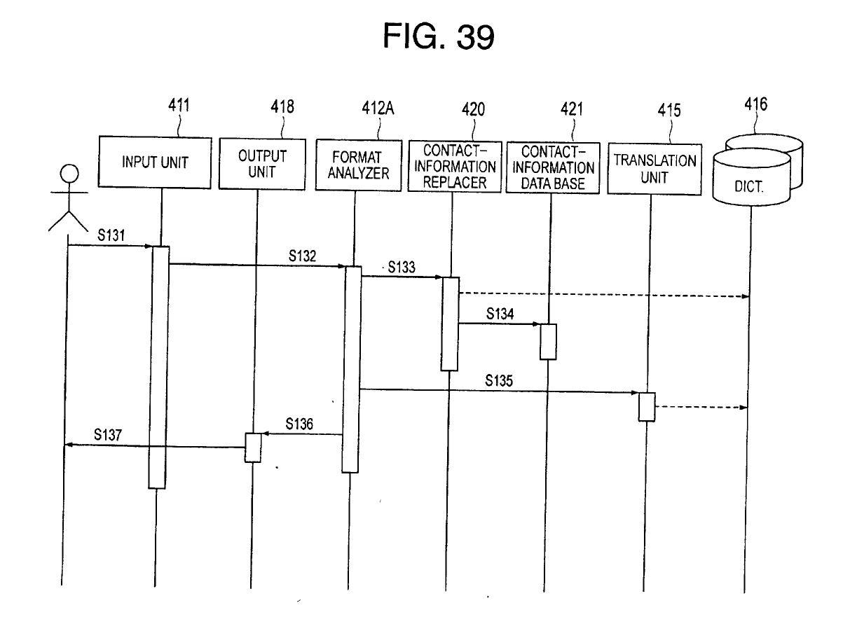

The operation of the machine translation system 401A in FIG. 38 is illustrated in FIG. 39. A person using a Web browser or the like at the input unit 411 enters or specifies a document to be translated from the first language to the second language (step S131). The document may have been obtained from a document retrieval system, for example, or translation of the document may be specified when retrieval is requested.

In the machine translation system 401A, the format of the input document is analyzed by the format analyzer 412A (step S132). If contact information is present in the analyzed document, this information is supplied to the contact-information replacer 420 (step S133). The contact-information replacer 420 uses the contact-information data base 421, and if necessary the dictionary unit 416, to convert the contact information to new contact information suitable for inclusion in the translation result (step S134).

Either after or in parallel with this replacement, the textual part of the input document is also submitted to the translation unit 415 (step S135) and translated from the first language to the second language by use of the dictionary unit 416. The completed translation result, including the new contact information, is supplied to the output unit 418 (step S136), and viewed by the person who requested the translation (step S137).

In a variation of the operation shown in FIG. 39, the input document is submitted by the author or provider of the document, to prepare translations for viewing by people who read other languages.

When a Web page or other document is translated by the machine translation system 401A, both the document provider and the person who reads the translated document benefit from the replacement of the original contact information with new contact information suitable for a region or country where the second language is spoken, or for a person who prefers use of the second language to the first language. If the document is a catalog or technical manual, for example, the new contact information may be the address of a customer relations office in a country in which the second language is spoken, which can directly deal with orders or inquiries from customers in that country.

The machine translation system 401A provides great flexibility in generating new contact information. For example, depending on the language into which the input document is translated, the new contact information may be an electronic mail address that was already supplied as contact information in the input document, or the address of a machine translation system that will translate mail from the second language to the first language.

The machine translation system 401A provides an efficient way in which to tailor the contact information in a document for different languages into which the document may be translated. It is not necessary for the person who creates the document to create a different version for each language, and it is not necessary to list contact information for all languages in the original document.

The machine translation system 401A may be configured as a stand-alone machine translation system, instead of being configured on a server on the Internet.

In the foregoing description of the fifth aspect of the invention, electronic mail addresses or other contact information in a document are always replaced with new information when the document is translated by the machine translation system, but this process may be controlled by a control flag embedded in the document, so that the replacement is made only if the control flag designates that the contact information may be replaced. Similar control flags or other control information may be used to distinguish contact information that is to be replaced from identical information (an identical address, for example) occurring in the body of the document, which is not to be replaced.

Although the several aspects of the invention have been described separately above, these aspects can be combined in various ways, and those skilled in the art will recognize that further variations are possible within the scope claimed below.

What is claimed is:

1. A machine-readable dictionary system used by a plurality of users for natural-language processing, comprising:
a plurality of system dictionaries organized in a tree structure with a root node, including a generalized terminology dictionary located at the root node, and specialized terminology dictionaries, located at successively lower levels of the tree structure, pertaining to successively narrower categories of natural-language material; and
an editor unit for adding user dictionaries to the tree structure by attaching each user dictionary to one of the system dictionaries, and adding information supplied by respective users to the user dictionaries.

2. The machine-readable dictionary system of claim 1, further comprising a manager unit for selecting the dictionaries in said dictionary system to be used for processing natural-language material submitted by one of said users, the natural-language material belonging to one of said categories, the manager unit selecting the dictionaries by following a path in said tree structure from the specialized terminology dictionary pertaining to said one of said categories up to said general terminology dictionary, selecting all system dictionaries on said path, and selecting all user dictionaries, belonging to said one of said users, that are attached to the selected system dictionaries.

3. The machine-readable dictionary system of claim 2, wherein for certain types of said natural-language material, the manager unit selects all user dictionaries attached to the selected system dictionaries, regardless of the users to whom the user dictionaries belong.

4. A machine-readable dictionary system used by a plurality of users for natural-language processing, comprising:
a system dictionary shared by said users;
a plurality of user dictionaries editable by different ones of said users; and
an incorporator unit for transferring information appearing in at least a certain number of said user dictionaries from said user dictionaries into said system dictionary.

5. A machine-readable dictionary system used by a plurality of users for natural-language processing, comprising:
a plurality of dictionaries organized in a hierarchical structure, including at least a first dictionary and a plurality of second dictionaries directly subordinate to the first dictionary; and
a unifier unit for transferring information appearing in at least a certain number of said second dictionaries into the first dictionary.

6. A machine-readable dictionary system used by a plurality of users for natural-language processing, comprising:
a first dictionary shared by said users;
a plurality of user dictionaries editable by different ones of said users; and
a splitter-generator unit for generating a second dictionary subordinate to the first dictionary, based at least on said user dictionaries.

7. The machine-readable dictionary system of claim.6, wherein:
said user dictionaries store entries, each entry among said entries each comprising a key and a value; and
if entries having a first key and a first value appear in at least a certain number of said user dictionaries, and entries having the first key and a second value appear in at least said certain number of said user dictionaries, the splitter-generator unit creates a pair dictionaries subordinate to the first dictionary, places an entry having the first key and the first value in one dictionary in said pair, and places an entry having the first key and the second value in another dictionary in said pair.

8. A machine translation system having a user dictionary editable by a user, comprising:
a processor for collecting words that could not be translated by the machine translation system; and
an editing unit for displaying the words collected by the processor and enabling the user to enter corresponding information for editing the user dictionary.

9. A machine translation system having a plurality of dictionaries, one of said dictionaries being a user dictionary to which a user can add information, comprising:
a reference unit for assisting said user in adding said information to the user dictionary by obtaining related information from dictionaries other than said user dictionary among said plurality of dictionaries; and
an editing unit for displaying said related information, and receiving from the user information to be added to said user dictionary.

10. A machine translation system having a plurality of dictionaries, and preparing to translate a source document by dividing said plurality of dictionaries into selected dictionaries and non-selected dictionaries, comprising:
a translation engine for translating the source document by using the selected dictionaries, and by using the non-selected dictionaries to translate words missing from the selected dictionaries, thereby obtaining a translation result; and
an extraneous translation highlighter for marking words in the translation result that were translated by use of the non-selected dictionaries, to make the marked words distinguishable from words that were translated by use of the selected dictionaries.

11. A machine translation system having a user dictionary editable by a user, comprising:
a translation unit for translating a source document from a source language into a target language, thereby obtaining a translation result; and
a display unit having a screen, for displaying the translation result in a first part of the screen while enabling the user to edit the user dictionary in a second part of the screen.

12. The machine translation system of claim 11, wherein the display unit displays words that the machine translation system was unable to translate in the second part of the screen.

13. A distributed natural-language processing system including a first apparatus having a natural-language-processing program and a second apparatus having a dictionary, wherein:
the first apparatus comprises
an uploader for sending the natural-language-processing program to the second apparatus, and
a commander for sending natural-language data to be processed to the second apparatus; and
the second apparatus comprises
a processor for storing the natural-language-processing program received from the first apparatus, and executing the natural-language-processing program to process the natural-language data received from the first apparatus, by use of the dictionary system, and
a storer for storing the natural-language-processing program received from the first apparatus in the processor.

14. The distributed natural-language processing system of claim 13, wherein the second apparatus has a plurality of processors for storing and executing different natural-language processing programs, said processor being one of said processors.

15. The distributed natural-language processing system of claim 13, wherein said distributed natural-language processing system performs machine translation.

16. The distributed natural-language processing system of claim 13, wherein:
the second apparatus also comprises a manager unit for sending result data to the first apparatus, the result data being obtained by processing of the natural-language data; and
the first apparatus also comprises a result output unit for output of the result data.

17. A machine translation and document display system that translates source text and generates translated text marked up according to a predetermined markup language by inclusion of markup symbols, comprising:
a script generator for embedding machine-executable script in said markup symbols, the machine-executable script including source text corresponding to translated text identified by corresponding markup symbols; and
a display and operation unit for displaying said translated text, and responding to operations on said markup symbols by executing said embedded machine-executable script, thereby displaying the source text included in said machine-executable script.

18. The machine translation and document display system of claim 17, wherein the source text and translated text are hypertext.

19. A machine translation and document display system that translates source text into translated text and generates a mixed document including at least the source text and the translated text, comprising:
an attribute generator for embedding markup symbols in said mixed document, the markup symbols dividing said mixed document into parts and subparts, each part of the mixed document including one subpart with part of the source text and another subpart with a corresponding part of the translated text, the subparts being identified by markup symbols specifying the language of the source text and the language of the translated text; and
a display and operation unit for receiving a language specification and selectively displaying the source text and the translated text in response to the language specification.

20. The machine translation and document display system of claim 19, wherein the source text and translated text are hypertext.

21. A machine translation system for translating a source document in a first language to obtain a translated document in a second language, the source document including contact information, the machine translation system comprising:
means for extracting the contact information from the source document;
means for generating new contact information, suitable for the second language, from the extracted contact information; and
means for inserting the new contact information into the translated document in place of the extracted contact information.

22. The machine translation system of claim 21, wherein the contact information is an electronic mail address.

23. The machine translation system of claim 22, further comprising means for translating electronic mail from the second language to the first language, wherein the new contact information is an electronic mail address of said means for translating.

24. The machine translation system of claim 21, wherein the new contact information designates a party understanding the second language.

25. The machine translation system of claim 21, further comprising:
a contact-information data base storing contact information suitable for different languages; and
an editing unit for editing the contact information stored in the contact-information data base.
